(19) United States
(12) Patent Application Publication
(10) Pub. No.: US 2010/0094865 A1
(43) Pub. Date: Apr. 15, 2010

(54) SYSTEMS AND METHODS FOR DISTRIBUTING AND MAINTAINING PRODUCT OR SERVICE INFORMATION

(76) Inventors: Michael R. Haswell, San Francisco, CA (US); Joerg Habermeier, San Francisco, CA (US); Randy Adams, Menlo Park, CA (US); Mark D. Kvamme, Atherton, CA (US)

Correspondence Address: JONES DAY, 222 EAST 41ST ST, NEW YORK, NY, 10017, US

(21) Appl. No.: 12/271,669

(22) Filed: Nov. 14, 2008

Related U.S. Application Data
(60) Provisional application No. 61/105,043, filed on Oct. 13, 2008.

(51) Int. Cl. G06F 17/30; G06F 17/00

(52) U.S. Cl. 707/723; 707/E17.108; 715/243; 715/764; 715/273

(57) ABSTRACT

Computer-executed methods, systems, and media provide a first webpage, responsive to a user request, prompting for a query. A search for products or services that match the query yields a search results schema, comprising a hit description for the results of the search. A plurality of result details layout schemas, each corresponding to a search result, is also obtained. The search results schema specifies a location of each result details layout schema. A second web page encoding a first and second representation is created. The first representation is for a first search result and is centered in the second web page. The second representation is of a second search result and is positioned in an off-center position in a manner that is rotated about a first axis of rotation. The first and second representations are respectively specified by first and second result details layout schemas.

### CROSS REFERENCE TO RELATED APPLICATION

This Application claim priority to U.S. Patent Application No. 61/105,043, filed Oct. 13, 2008, which is hereby incorporated by reference herein in its entirety.

### FIELD OF THE INVENTION

This application generally relates to computer-executed methods, systems, and media are provided for distributing and maintaining product information over the Internet.

### BACKGROUND

Internet-based commerce is a major industry world-wide. Typical Internet-based commerce websites present a shopper with a wide variety of products for purchase when the shopper visits the websites (e.g., using a standard web browser). Through a webpage interface, the shopper may choose desired products from among the wide variety of presented products. The shopper may purchase chosen products, for example, by using a standard credit card authorization interface. The chosen products may then be shipped to the shopper or some other address provided by the shopper through the website interface.

Some Internet-based commerce sites are linked to a specific manufacturer or type of product and allow shoppers to choose from only a limited array of products from that manufacturer or that type. Others are more general sites that allow shoppers to select from a wide array of product types from a wide array of manufacturers. While some of these Internet-based commerce sites provide shoppers with a department store-like shopping experience where the sites present the shopper with the products of only large sellers or manufacturers, others provide shoppers with a more market-like shopping experience where the site presents the shopper with products from smaller or individual sellers or manufacturers. In any case, shoppers at Internet-based commerce sites are typically presented with a vast number of products of different types, colors, origins, etc. from which to choose.

The vast number of Internet-based commerce sites in existence today allows consumers access to a huge array of products. These products are traditionally manufactured by a corporation, manufacturer or individual and offered for sale, either by that corporation or individual or some other entity, through one of the vast number of Internet-based commerce sites.

What is needed in the art are improved systems and methods for helping users to identify, organize and share product information of interest.

### BRIEF SUMMARY

One embodiment provides computer-executed methods, systems, and computer-readable media for creating or providing a first webpage, responsive to a user request, which prompts for a query from a user. A search for products or services that match the query (e.g., in a database) yields a search results schema, comprising a hit description for the results of the search. A plurality of result details layout schemas, each corresponding to a search result, is also obtained. The search results schema specifies a location of each result details layout schema. A second web page encoding a first and second representation is created. The first representation is for a first search result and is centered in the second web page. The second representation is of a second search result and is positioned in an off-center position in a manner that is rotated about a first axis of rotation. The first and second representations are respectively specified by first and second result details layout schemas.

Another embodiment provides computer-executed methods, systems, and computer-readable media for sending a query for a first web page using an Internet browser. A first web page received from a first remote computer is displayed in response to the query. The first web page includes instructions for prompting a user for a product or service query. Responsive to the displaying of the first web page, a product or service query is sent. A second web page is displayed using an information construct. The information construct comprises a search results schema or is derived from the search results schema. The search results schema comprises a hit description for each search result in a plurality of search results for the product or service query. A hit description in the search results schema specifies a location of a result details layout schema in a plurality of result details layout schemas. Further, the second web page comprises instructions for encoding a first representation of a first search result in the plurality of search results in a center position of said second web page, where the first representation is specified by the search results schema and a first result details layout schema in the plurality of result details layout schemas. Also, the second web page comprises instructions for encoding a second representation of a second search result in the plurality of search results in a first off-center position of the second web page relative to the first representation. The second representation is rotated about a first axis of rotation that lies between the center position and the first off-center position of the second web page. The second representation is specified by the search results schema and a second result details layout schema in the plurality of result details layout schemas.

Another embodiment provides computer-executed methods, systems, and computer-readable media for displaying information in which, responsive to a user query, an album is obtained from a remote computer. The album comprises a plurality of links to a plurality of Internet-accessible documents, each link in the plurality of links specifying a location of an Internet-accessible document in the plurality of Internet-accessible documents. A first link in the plurality of links is a link to a first static graphic representation stored in a document repository in a remote location, where the first static graphic representation is of a document retrieved from the Internet at a time before the obtaining. A second link in the plurality of links is a link to a location of a first image for a selected search result from a hit description for the selected search result in a search results schema. Responsive to the user query, all or a portion of the plurality of Internet-accessible documents in the plurality of Internet-accessible documents are retrieved over the Internet including the first static graphic representation and the first image. All or a portion of the plurality of Internet-accessible documents in the plurality of Internet-accessible documents are displayed on a graphic output device.

Another embodiment provides computer-executed methods, systems, and computer-readable media for receiving a query for product or service information. Responsive to the query, a search results schema for a plurality of products or services that match the query is generated or retrieved. The search results schema comprises a hit description for all or a portion of the products or services in said plurality of plurality of products or services. Further, responsive to the query a plurality of result details layout schemas are generated or retrieved. Each result details layout schema in the plurality of result details layout schemas corresponds to a product or service in the plurality of products or services. The search results schema specifies a location for each result details layout schema in all or a portion of the plurality of result details layout schemas. A first web page is created. The first web page comprises instructions for encoding a first representation of a first product or service in the plurality of products or services in a center position of the first web page. The first representation is specified by the search results schema and a first result details layout schema in the plurality of result details layout schemas. A second representation of a second product or service in the plurality of products or services is encoded in a first off-center position of the second web page relative to the first representation. The second representation is rotated about a first axis of rotation that lies between the center position and the first off-center position of the second web page. The second representation is specified by the search results schema and a second result details layout schema in the plurality of result details layout schemas.

Another embodiment provides computer-executed methods, systems, and computer-readable media for sending a product or service query and displaying a first web page using an information construct. The information construct comprises a search results schema or is derived from the search results schema. The search results schema comprises a hit description for each product or service in a plurality of products or services that match the product or service query. A hit description in the search results schema specifies a location of a result details layout schema in a plurality of result details layout schemas. The first web page comprises instructions for encoding a first representation of a first search result in the plurality of search results in a center position of said first web page. The first representation is specified by the search results schema and a first result details layout schema in the plurality of result details layout schemas. The first web page also comprises instructions for encoding a second representation of a second search result in the plurality of search results in a first off-center position of the second web page relative to the first representation. The second representation is rotated about a first axis of rotation that lies between the center position and the first off-center position of the first web page. The second representation is specified by the search results schema and a second result details layout schema in the plurality of result details layout schemas.

### BRIEF DESCRIPTION OF THE SEVERAL VIEWS OF THE DRAWING

FIG. 1 illustrates a computer system for distributing and maintaining product or service information in accordance with some embodiments.

FIG. 2 illustrates an album database in accordance with some embodiments.

FIG. 3 illustrates a method for distributing and maintaining product or service information in accordance with some embodiments.

FIG. 4 illustrates the text of an exemplary extensible markup language (XML) document for storing links to web pages and/or links to static graphic representations of web pages in an album, in accordance with some embodiments.

FIG. 5 illustrates a computer readable interface for distributing and maintaining product or service information in accordance with an exemplary embodiment in which a user can shop by category for products.

FIG. 6 illustrates a computer readable interface for distributing and maintaining product or service information in accordance with an exemplary embodiment in which a user has selected to shop for products under the category “Dirt Bike Parts.”

FIG. 7 illustrates a computer readable interface for distributing and maintaining product or service information in accordance with an exemplary embodiment in which a user browses for products under the category “Dirt Bike Parts” using a pageflow architecture.

FIG. 8 illustrates a computer readable interface for distributing and maintaining product or service information in accordance with an exemplary embodiment in which a description of a first search result, a title of a first search result, and a URL that contains more information about a first search result is displayed when a user mouses over a portion of the first search result.

FIG. 9 illustrates a computer readable interface for distributing and maintaining product or service information in accordance with an exemplary embodiment in which an option to add the first search result to a working stack (album) or a new stack is provided.

FIG. 10 illustrates a computer readable interface for distributing and maintaining product or service information in accordance with an exemplary embodiment in which a first search result has been added to a stack.

FIG. 11 illustrate a computer readable interface for distributing and maintaining product or service information in accordance with an exemplary embodiment in which a toggle bar is used to review search results.

FIG. 12 illustrates a computer readable interface for distributing and maintaining product or service information in accordance with an exemplary embodiment in which a user has toggle to a second search result in a plurality of search results.

FIG. 13 illustrates a computer readable interface for distributing and maintaining product or service information in accordance with an exemplary embodiment in which a full set of stack options, including “view”, “share”, “delete”, and “new” is provided in response to a user query.

FIG. 14 illustrates a computer readable interface for distributing and maintaining product or service information in accordance with an exemplary embodiment in which a user is presented with an option to add the first search result to a stack.

FIG. 15 illustrates a computer readable interface for distributing and maintaining product or service information in accordance with an exemplary embodiment in which a full set of stack options, including “view”, “share”, “delete”, and “new” is provided in response to a user query and in which the user has elected the option to share the stack.

FIG. 16 illustrates a computer readable interface for distributing and maintaining product or service information in accordance with an exemplary embodiment in which a full set of stack options, including “view”, “share”, “delete”, and “new” is provided in response to a user query and in which the user has elected the option to share the stack by adding the source code for the stack to a blog or web.

Like reference numerals refer to corresponding parts throughout the several views of the drawings.

### DETAILED DESCRIPTION

In one aspect, computer-executed methods, systems, and media provide a first webpage, responsive to a user request, prompting for a query. A search for products or services that match the query yields a search results schema, comprising a hit description for the results of the search. A plurality of result details layout schemas, each corresponding to a search result, is also obtained. The search results schema specifies a location of each result details layout schema. A second web page encoding a first and second representation is created. The first representation is for a first search result and is centered in the second web page. The second representation is of a second search result and is positioned in an off-center position in a manner that is rotated about a first axis of rotation. The first and second representations are respectively specified by first and second result details layout schemas.

In some embodiments, a plug-in provides an opportunity to quickly and easily display dynamic search results in an interactive and visually refined manner. The content is displayed in a pageflow user interface, complete with reflections. Site visitors can: (i) flip through search results one by one, (ii) click on any visible result slide, (iii) use a slider bar to navigate among all available results, and (iv) add results into a “stack.” As used herein, the terms “stack” and “album” are interchangeable. In some embodiments, for optimized performance, results are loaded ten at a time and the next set of results is loaded when only four unviewed results remain. The loading of additional results is seamless for users. Previously viewed results are immediately available.

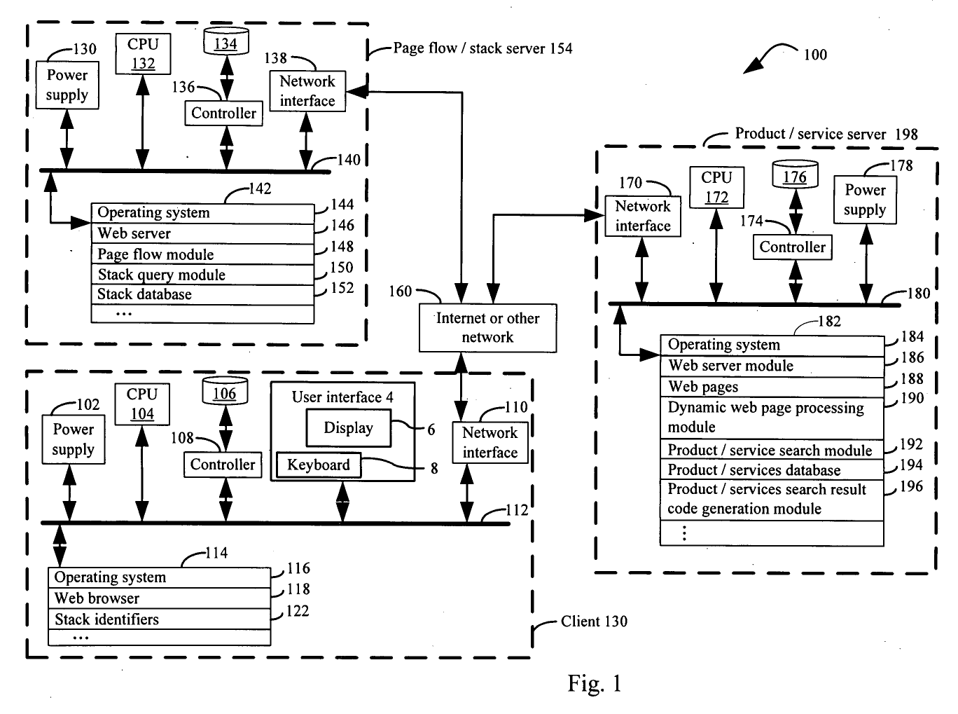

FIG. 1 illustrates a computer system 100 for distributing and maintaining product or service information in accordance with some embodiments. Computer system 100 comprises a product/service server 198, an Internet or other network 160, one or more client devices 130, and a page flow/stack (album) server 154. Product/service server 198 comprises:
one or more processing units (CPUs) 172;
a network or other communications interface 170;
a memory 182;
one or more magnetic disk storage devices or other forms of non-volatile memory 176;
one or more controllers 174 for accessing the one or more magnetic disk storage devices 176;
one or more communication busses 180 for interconnecting the aforementioned components; and
a power supply 178 for powering the aforementioned components.
   Data in memory 182 can be seamlessly shared with non-volatile memory 176 using known computing techniques such as caching. Memory 182 and/or memory 176 can include mass storage that is remotely located with respect to the one or more central processing units 172. In other words, some data stored in memory 182 and/or memory 176 may in fact be hosted on computers that are external to product/service server 198 but that can be electronically accessed by product/service server 198 over an Internet, intranet, or other form of network or electronic cable using network interface 170.

Product/service server 198 is connected via Internet/network 160 to one or more client devices 130. FIG. 1 illustrates the connection to only one such client device 130. However, in practice, product/service server 198 can be connected to 10 or more different clients, 100 or more clients, or 1000 or more clients, or 10,000 or more clients, and more typically still, 100,000 or more of the clients. It will be appreciated by those of skill in the art that product/service server 198 may in fact have a computer architecture that is more complex than that shown in FIG. 1. For instance, a front end set of servers may be used to receive and distribute search queries from numerous client 130s among a set of back-end servers that actually process the search queries. In such a system, product/service server 198 as shown in FIG. 1 would be one such back-end server.

In some embodiments, memory 182 stores:
an operating system 184 that includes procedures for handling various basic system services and for performing hardware dependent tasks;
a web server module 186 (e.g., the Apache HTTP server, Miscrosoft IIS, Google GWS, Oversee, lighttpd, nginx, etc.) that is used to serve web pages to various clients 130 via one or more communication networks 160, such as the Internet, other wide area networks, local area networks (e.g., a local wireless network can connect the clients 130 to product/service server 198), metropolitan area networks, and so on;
one or more web pages 188 that contain product or service information that is distributed to one or more clients 130;
a dynamic web page processing module 190 (e.g., PHP, Javascript, Java) for processing dynamic instructions in the one or more web pages 188;
an optional product/service search module 192 for searching for products and services that match a product/service query from a client;
a product/services database 194 (e.g., COLDFUSION® or MySQL database) that comprises information about products or services; and
a product/services search result code generation module 196 for generating code (e.g., XML) that describes one or more products or services in products/services database 194.

In typical embodiments, a client device 130 includes:
one or more processing units (CPUs) 104;
a network or other communications interface 110;
a memory 114;
optionally, one or more magnetic disk storage devices 106 accessed by one or more optional controllers 108;
a user interface 4, the user interface 4 including a display 6 and a keyboard or other input device 8;
one or more communication busses 112 for interconnecting the aforementioned components; and
a power supply 102 for powering the aforementioned components.

In some embodiments, data in memory 114 can be seamlessly shared with optional non-volatile memory 106 using known computing techniques such as caching. In some embodiments, the client device 130 does not have a magnetic disk storage device 106. For instance, in some embodiments, in some embodiments the client device 100 is a portable handheld computing device. In some embodiments, network interface 110 communicates with Internet/network 160 by wireless means.

In some embodiments, memory 114 stores:
an operating system 116 that includes procedures for handling various basic system services and for performing hardware dependent tasks and that is used for connecting client device 130 to the Internet or other network 160;
a web browser 118 for viewing albums, web pages, static graphic representations and other information on client device 130; and
stack identifiers 122 that identify one or more stacks (albums) associated with a user of client device 130.

In some embodiments, the web browser 118 includes plugin that relies on the ADOBE® Flash Player version 9 or equivalent functionality. Thus, in some embodiments, memory 114 and or memory 106 further includes ADOBE® Flash Player version 9 or equivalent functionality (not shown).

Page flow/stack server 154 comprises:
one or more processing units (CPUs) 132;
a network or other communications interface 138;
a memory 142;
one or more magnetic disk storage devices or other forms of non-volatile memory 134;
one or more controllers 136 for accessing the one or more magnetic disk storage devices or other forms of non-volatile memory 134;
one or more communication busses 140 for interconnecting the aforementioned components; and
a power supply 130 for powering the aforementioned components.
   Data in memory 182 can be seamlessly shared with non-volatile memory 176 using known computing techniques such as caching. Memory 182 and/or memory 176 can include mass storage that is remotely located with respect to the one or more central processing units 172. In other words, some data stored in memory 182 and/or memory 176 may in fact be hosted on computers that are external to product/service server 198 but that can be electronically accessed by product/service server 198 over an Internet, intranet, or other form of network or electronic cable using network interface 170.

Page flow/stack server 154 is connected via Internet/network 160 to one or more product/service servers 198 and/or one or client devices 130. FIG. 1 illustrates the connection to only one such product/service server 198. However, in practice, page flow/stack server 154 can be connected to 10 or more different product/service servers 198, 100 or more product/service servers 198, 1000 or more product/service servers 198, or 10,000 or more product/service servers 198. FIG. 1 illustrates the connection to only client 130. However, in practice, page flow/stack server 154 can optionally be connected to 10 or more clients 130, 100 or more product/service clients 130, 1000 or more product/service clients 130, or 10,000 or more product/service clients 130.

It will be appreciated by those of skill in the art that page flow/stack server 154 may in fact have a computer architecture that is more complex than that shown in FIG. 1. For instance, a front end set of servers may be used to receive and distribute requests from numerous product/service servers 198 among a set of back-end servers that actually process the request. In some embodiments, memory 142 stores:
an operating system 144 that includes procedures for handling various basic system services and for performing hardware dependent tasks, such as communication with one or more product/server servers 198 and optionally one or more client devices 130;
a web server module 146 (e.g., the Apache HTTP server, Miscrosoft IIS, Google GWS, Oversee, lighttpd, nginx, etc.) that is used to serve information to various product/service servers 198 and optionally one or more client devices 130 via one or more communication networks 160, such as the Internet, other wide area networks, local area networks, metropolitan area networks, and so on;
a page flow module 148 that is used to serve a page flow plugin to one or more product/service servers 198 and/or one or more client devices 130;
a stack query module 150 that is used to locate, update, and serve one or more stacks from a stack database 152 in response to requests received over the Internet or other network 160 in accordance with an embodiment of the present invention; and
a stack database 152 (e.g., COLDFUSION® database or MySQL database) that comprises a plurality of stacks.

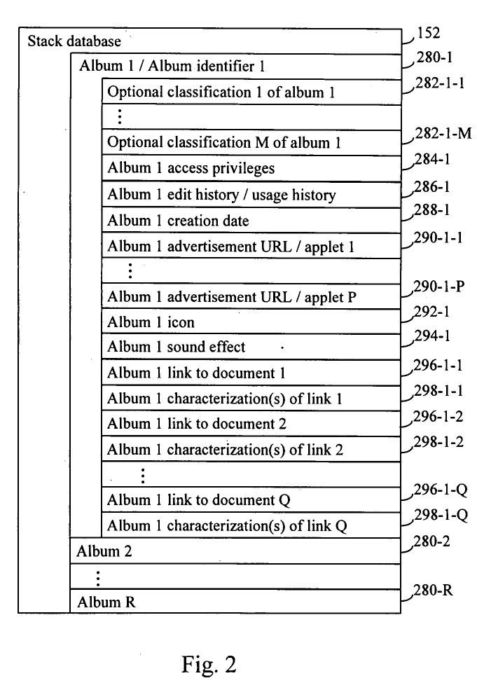

An exemplary stack database 152 is illustrated in FIG. 2. In some embodiments, what is communicated is a link to an album (stack) rather than the stack itself. The link to the album contains sufficient information for stack query module 150 to locate the corresponding album (stack) 280 in stack database 152. For example, the link may simply be the value of an identifier that uniquely identifies the album 280. To retrieve an album, the links 296 in the album are used to retrieve individual web sites, static graphic representations, or other documents 296 referenced by the album 180.

Optionally, in some embodiments, each album 180 has one or more classifications 282. Such classifications can be, for example, the classifications of the vertical collections that contain documents that are linked by the album 280. For example, consider the case in which there is a particular web page in a vertical collection and a link to this web page is in an album 280. In this example, the characteristics of the vertical collection containing the web page can be used to classify the album 280, and this classification can be stored as a classification 282 of the album 280. An album can have many classifications, for example, it can have the classification “cell phones,” “electronics,” and “not consumer complaints.” More information on vertical collections is found in United States Patent Publications 2007/0244862, 20070244863, and 2008/0082554 each of which is hereby incorporated by reference.

In some embodiments there are public albums 180 that can be viewed by everyone and there are private albums 180 that can only be viewed by select users or select programs. In some embodiments, all albums are public meaning that they can be viewed by everyone, but only the creator of the album can has edit privileges. These are all examples of access privileges 284 that are stored in the album 180 in some embodiments. In some embodiments, access privileges 284 specify who can review the album 180, add or delete “pages” in the album 280, share the album 280, print the album 280, delete the album 280, copy the album 280, and/or annotate album documents 296. In some embodiments, rather than having album privileges 284, there are multiple identifiers to a given album, where the actually identity of identifier indicates the access privileges. Thus, if a first identifier to a given album 280 is shared, the recipient of the identifier can only view the album 280, whereas if a second identifier to a given album 280 is shared, the recipient of the identifier has full privileges to the album 280, including the right to modify, share, print, delete, or copy the album. In some embodiments, all users have the right to share and copy an album 280 so that albums become widely distributed across a broad user group. As described herein, in some embodiments, to share an album 280, all that is required is to share the album 280 identifier with one or more recipients.

Advantageously, in some embodiments, albums 280 contains an optional edit history 286 that indicates the last date in which an album was edited. In some embodiments, edit history 286 is a comprehensive edit history that indicates (i) when each link to a document 296 was added to the album, (ii) who added the link to the album 280, (iii) whether any links were deleted from the album 280 and, if so, the links that were deleted, (iv) how many times the album 280 has been accessed, (v) who has accessed the album 280, (vi) when was the last time the album 280 was accessed, and/or (vii) how many times the album 280 has been shared. Optional edit history 284 can contain any combination of such information or any other information that relates to the modifications or usage history of album 280.

In some embodiments, the creation date 288 of an album 280 is stored in the album. In some embodiments, the creation date 288 is not stored and in some embodiments the creation date is simply stored as edit history information 286. In some embodiments, based on one or more of the optional classifications 282 of an album 280, album edit history and/or usage history 286, creation date 288, an identity or characteristic of any combination of the documents 296 linked by the album 180, or any other information associated with the album 280 and/or stored in the album 280, selected advertisements 290 are associated with the album 20. In some embodiments, these optional advertisements 290 are stored in the album 280 itself. In some embodiments, optional advertisements 290 are links to advertisements that are stored in a separate optional advertisement repository. In some embodiments, advertisements 290 are not stored in album 280 but rather, whenever an album is viewed some combination of one or more of the classifications 282 of the album 280, the album edit history and/or usage history 286, the album creation date 288, an identity or characteristic of any combination of the documents 296 linked by the album 280, or any other information associated with the album and/or stored in the album is sent to a software module (e.g., an advertisement module) in or electronically accessible form to a software module that manages an advertisement repository 156. Based on the information sent to the software module, one or more appropriate advertisements are pulled from the advertisement database (not shown) and either integrated directly into the album 180 as separate pages of the album or are displayed along with the album 180 when the album is being viewed (e.g., as background, as a side panel, in a pop-window etc.). In some embodiments, the advertisement is an interactive widget, such as a query form for a retailer that allows a user to enter information, such as billing information, and order products. Thus, in some embodiments, advertisements 290 are temporarily integrated into an album and displayed only once. In other embodiments, advertisements 290 are integrated into an album and persist in the album for a finite number of views. For example in some embodiments, an advertisement 190 is integrated into an album without human intervention and persists in the album 180 until the page in the album 180 containing the advertisement has been viewed a predetermined number of times (e.g., between one and ten times, more than once, more than five times, more than 100 times) or by a predetermined number of different album recipients (e.g., between one and ten album recipients, more than one album recipient, more than five album recipients, more than 100 album recipients). In some embodiments, an advertisement 290 persists permanently within an album (either directly or as link to the album). In some embodiments, an advertisement 290 persists within an album (either directly or as link to the album) for a predetermined period of time (e.g., for an hour or less, between one and five hours, for ten hours or less, for a number of days, for a month or less, etc.).

In some embodiments, the amount of money paid by an advertiser to host an advertisement 290 in an album is a function of the popularity of an album 280 as determined by any kind of metric such as, for example, how often an album is shared, how many times the album has been shared, the classification 282 of the album, the characterization of any of the links contained in the album 282, an identity of the person that created the album, or simply based upon agreed upon price.

Continuing to refer to FIG. 2, in some embodiments, when an album 280 is shared, an icon is graphically displayed that gives an indication of the contents of the album. In some embodiments, this icon is stored as icon 292 in the album 280. In some embodiments, the icon 292 is a scaled down representation of the web page or static graphic representation of the first link in the album 280. In some embodiments, the icon 292 is a graphic representation of an album 280 classification 282. Likewise, in some embodiments when an album 280 is shared, a sound effect (e.g., a clip of a song, a distinct ring tone, etc.) is sound to announce the invitation to view the album 280. In some embodiments, the sound is stored as sound effect 294 in the album 280. In some embodiments the icon 292 and/or sound effect 294 are, in fact, advertisements. In such embodiments, advertisers pay to have certain icons 292 and/or sound effects 294 associated with albums 280.

As discussed above, an album contains one or more links 296, where each link 296 uniquely identifies a static graphic representation of a document such as a web page, a static graphic representation of a document such as a web page, one or more records in a database (e.g., a database accessed using COLDFUSION® or MySQL, etc.). In some embodiments an album 280 comprises links to actual URLs on the Internet. In some embodiments, the characterization of each document referenced by an album 280 is known and such characterizations 298 are associated with their corresponding links in album 280 and stored in the album 280. More information on albums is found in U.S. patent applications Ser. No. 12/131,087, filed May 31, 2008, Ser. No. 12/142,759, filed Jun. 19, 2008 and Ser. No. 12/142,771, filed Jun. 19, 2008 each of which is hereby incorporated by reference herein in its entirety.

In some embodiments, a static graphic representation of a web page is a bitmapped or pixmapped image of the web page. As used herein, a bitmap or pixmap is a type of memory organization or image file format or data structure used to store a digital image. A bitmap is a map of bits, a spatially mapped array of bits. Bitmaps and pixmaps refer to the similar concept of a spatially mapped array of pixels. Raster images in general may be referred to as bitmaps or pixmaps. In some embodiments, the term bitmap implies one bit per pixel, while a pixmap is used for images with multiple bits per pixel. One example of a bitmap is a specific format used in WINDOWS® that is usually named with the file extension of .BMP (or .DIB for device-independent bitmap). Besides BMP, other file formats that store literal bitmaps include InterLeaved Bitmap (ILBM), Portable Bitmap (PBM), X Bitmap (XBM), and Wireless Application Protocol Bitmap (WBMP). In addition to such uncompressed formats, as used herein, the term bitmap and pixmap refers to compressed formats. Examples of such bitmap formats include, but are not limited to, formats such as JPEG, TIFF, PNG, and GIF, to name just a few, in which the bitmap image, as opposed to the vector image, is stored in a compressed format. JPEG is usually lossy compression. TIFF is usually either uncompressed, or losslessly Lempel-Ziv-Welch compressed like GIF. PNG uses deflate lossless compression, another Lempel-Ziv variant. More disclosure on bitmap images is found in Foley, 1995, Computer Graphics: Principles and Practice, Addison-Wesley Professional, p. 13, ISBN 0201848406 as well as Pachghare, 2005, Comprehensive Computer Graphics: Including C++, Laxmi Publications, p. 93, ISBN 8170081858, each of which is hereby incorporated by reference herein in its entirety.

In typical uncompressed bitmaps, image pixels are generally stored with a color depth of 1, 4, 8, 16, 24, 32, 48, or 64 bits per pixel. Pixels of 8 bits and fewer can represent either grayscale or indexed color. An alpha channel, for transparency, may be stored in a separate bitmap, where it is similar to a greyscale bitmap, or in a fourth channel that, for example, converts 24-bit images to 32 bits per pixel. The bits representing the bitmap pixels may be packed or unpacked (spaced out to byte or word boundaries), depending on the format. Depending on the color depth, a pixel in the picture will occupy at least n/8 bytes, where n is the bit depth since 1 byte equals 8 bits. For an uncompressed, packed within rows, bitmap, such as is stored in Microsoft DIB or BMP file format, or in uncompressed TIFF format, the approximate size for a n-bit-per-pixel (2ⁿ colors) bitmap, in bytes, can be calculated as: size≈width×height×n/8, where height and width are given in pixels. In this formula, header size and color palette size, if any, are not included. Due to effects of row padding to align each row start to a storage unit boundary such as a word, additional bytes may be needed.

In some embodiments, the static graphic representation is generated using a web browser for which source code is available, such as MOZILLA® FIREFOX®. A static graphic representation of a web page can be an image of the rendered web page at a given instant in time or a time averaged representation of the web page over a period of time (e.g., one second or more, ten seconds or more, a minute or more, two minutes or more, etc.). Thus, a static graphic representation fully encompasses dynamic web pages that include applets such as ticker tapes or other dynamic components that cause the representation of the web page to change over time. Any dynamic components in a web page can either be ignored when constructing the word map for the document encoding the web page, averaged over a period of time, or a snapshot of such dynamic components (e.g., snapshots) can be used for the purposes of constructing the static graphic representation of the web page.

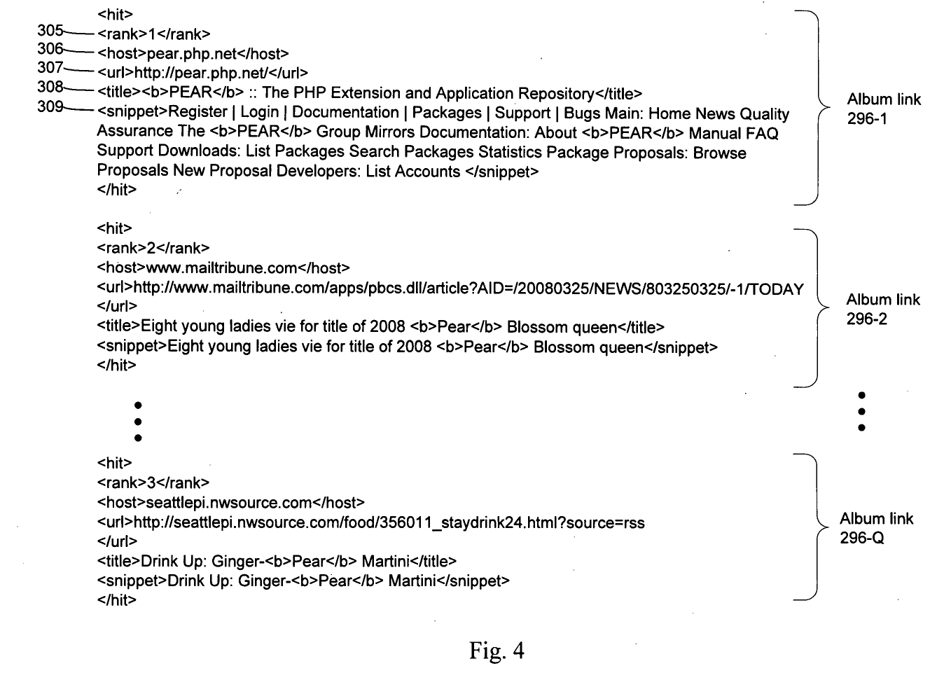

FIG. 4 illustrates exemplary code that can be used to store album links 296 in an album 280. In some embodiments, as in the case of hit results responsive to a user query, each respective link 296 in the album includes a rank 305 that ranks or otherwise orders the respective link 196. Rank 305 serves to order album links 296 (e.g., the first link 296 is for the first page of the album and so forth) and this order can be edited by a user when reviewing or creating the album defined by the code illustrated in FIG. 4. In some embodiments rank 305 is not used in albums 280 but is optionally present in the computer readable media. In the embodiment illustrated in FIG. 4, the entries for each respective link 296 further include an identifier for the source host (domain) 306 from which the document associated with the respective link was obtained, the actual uniform resource location (URL) 307 for the document (e.g., URL to a static graphic representation of a web page), a title 308 for the link, and an annotation 309 for the link.

In the embodiment illustrated in FIG. 4, the title 308 of the link 296 is typically the title of the web page or other document to which the link 296 points. For example, if document is a web page and includes a <TITLE> </TITLE> element, the code or text bounded by the <TITLE> </TITLE> element in the web page can serve as the title 308 of the line 296. In some alternative embodiments, title 308 is selected or edited by the user that added the link 296 to the album 280. The annotation 309 for the link 296 is, in some embodiments, a selection of words within the document pointed to by the link that relate to a query that was used by the user to find the document using a search engine. In some embodiments, any or all of the elements 305, 306, 307, 308, and 309 are stored in an album 280 along with any of the elements described above in conjunction with FIG. 2.

Of course, there is no requirement that albums 280 be stored in the format illustrated in FIG. 4. As indicated above, the XML code in FIG. 4 is merely one exemplary embodiment in which the album 280 is stored. At a minimum, an album 280 contains a plurality of links, where each such link 296 in the plurality of links is an address of a static graphic representation of a web page, a web page, or some other document with an Internet or network address (e.g., a field in a database). The album 280 can be stored in ASCII or binary format, or any other computer readable format. In some embodiments, the album 280 does not contain documents but rather just links 296 to the documents.

Regardless of the form used to store the album 280, the album itself can be stored locally, e.g., on client device 130, or remotely, e.g., on a server running a search engine (not shown). In typically embodiments, each respective link 296 in an album 280 contains the full address or other form of identifier that is sufficient to retrieve the document identified by the respective link 296 from a remote computer. As defined herein, a “remote computer” is any computer that must be accessed over Internet or other form of network 160. A user of client device 130 can have any number of albums 180 that are accessible to client computer 130 by stack identifiers 122 although such albums may be stored remotely in stack database 152 on page flow/stack server 154. For example a user can have one or more albums 280, more than ten albums 280, or more than 100 albums 280, each of which can, independently be stored locally or remotely.

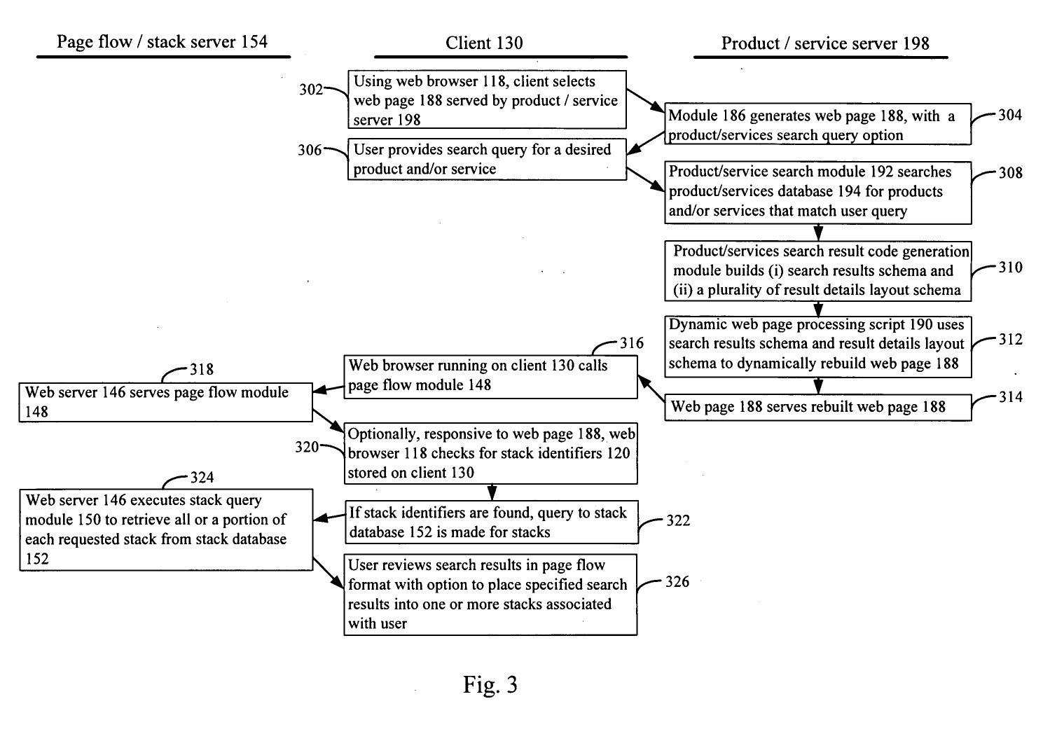

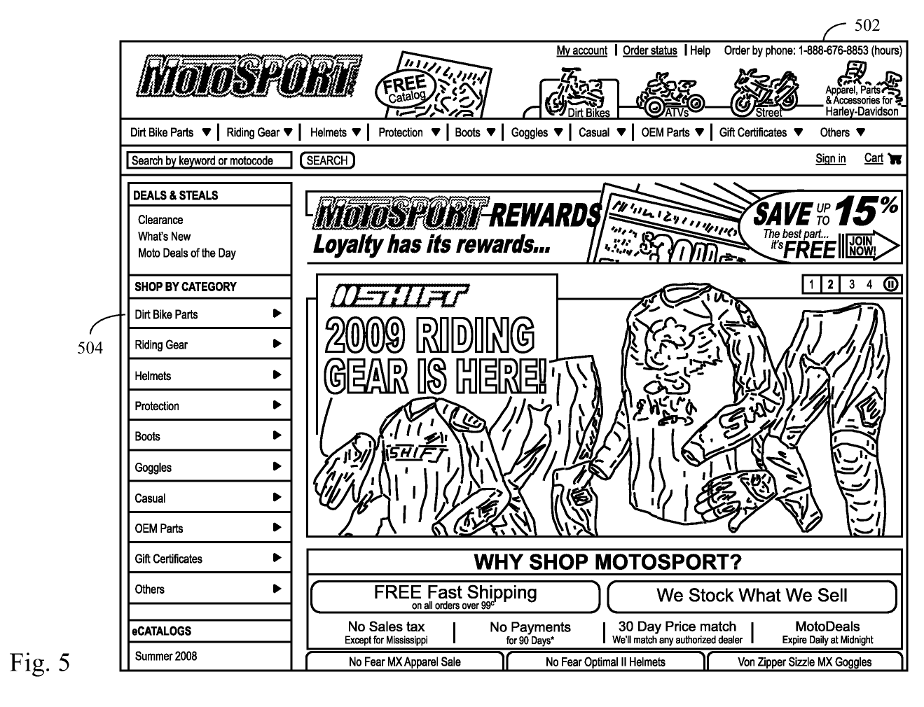

FIG. 3 provides is an illustrative method of distributing and maintaining product information over the Internet. In step 302, using web browser 118, a client selects a web page 188 served by product/service server 198. Product/service server 198 receives the query for the first web page. In step 304, web server module 186 generates a first web page 188. In some embodiments the first web page includes instructions for prompting a user for a product or service query. For example, referring to FIG. 5, in the first web page 502, the user is prompted to select between the categories “Dirt Bike Parts”, “Riding Gear”, “Helmets”, and so forth. In other examples, not shown, the first web page includes instructions for prompting a user to type in a product or service query.

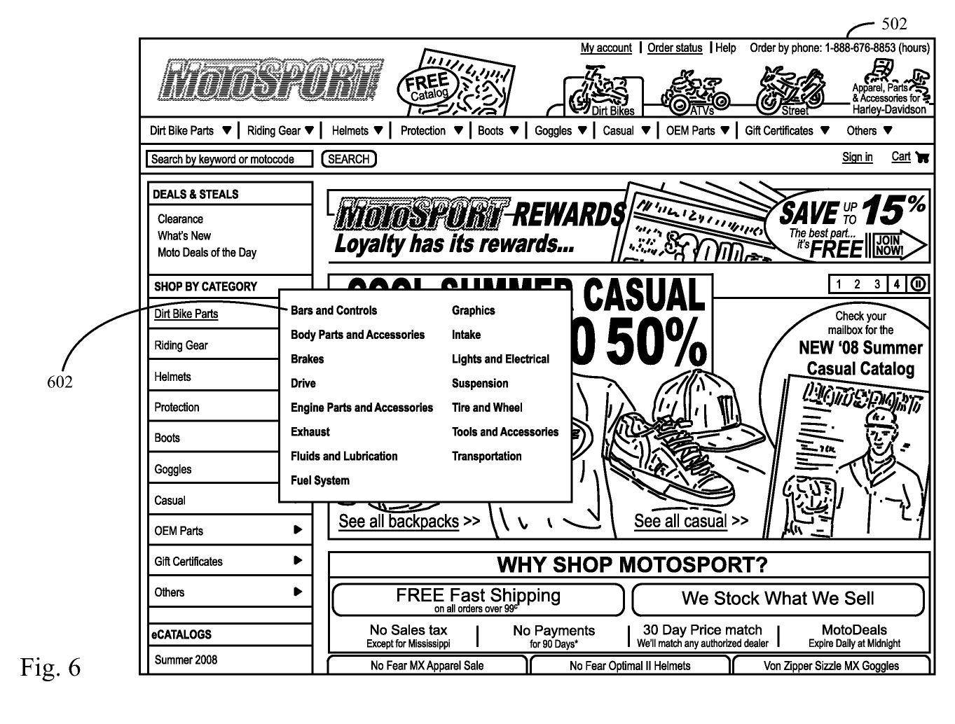

In step 306, using web browser 118, a user provides a search query for a desired product and/or service. For example, referring to FIG. 5, in one example, the user selects the category “shop by category” from page 502 and the subcategory “Bars and Controls” 602 as illustrated in FIG. 6. In other examples, not shown, a user types in a search request rather than or in addition to selecting a category.

In step 308, product/service server 198 receives, responsive to the provision of the first web page to the client 130, a product or service query. The product/service search module 192 searches for one or more products or one or more services in products/services database that matches the product or service query thereby obtaining a plurality of search results. In some embodiments, the plurality of search results is information about 5 or more products or services, 10 or more products or services, 20 or more products or services, or 100 or more products or services.

In step 310, product/services search result code generation module 196 builds, retrieves, creates, or generates (i) a search results schema and (ii) a plurality of results details layout schema. The search results schema comprises a hit description for all or a portion of the search results in the plurality of search results. Each result details layout schema in the plurality of result details layout schemas corresponds to a search result in the plurality of search results. The search results schema specifies a location for each result details layout schema in all or a portion of the plurality of result details layout schemas.

In some embodiments, the search results schema is XML code that contains a set of a predetermined number of results (e.g., up to 10 results, up to 20 results, etc.) along with a URL to the next “page” of results. In some embodiments, information for each result for the user query is represented in a “hit” node. In some embodiments, the search results schema comprises, for each hit in the search results schema, one or more of the following: (i) a snippet, which is brief description of the search item, (ii) a title, which is a headline for the search item, (iii) a uniform resource location (URL) that the user will be directed to when a slide is clicked, (iv) a content URL, which is the location of the result details layout schema for the search item, and/or (v) an image URL, which is a location for the image file to be displayed in a stack preview icon.

The following exemplary code is an example of a search results schema. In the exemplary code, search result hits are embedded in a results element “<results” (line 2) “/results>” (line 98). The URL for the search results schema that contains the next batch of hits responsive to a user query is set forth on lines 3-4 of the exemplary code. Each search result in the search results schema is embedded in a hit element (e.g., “<hit>” on line 6 through “</hit>” on line 19).

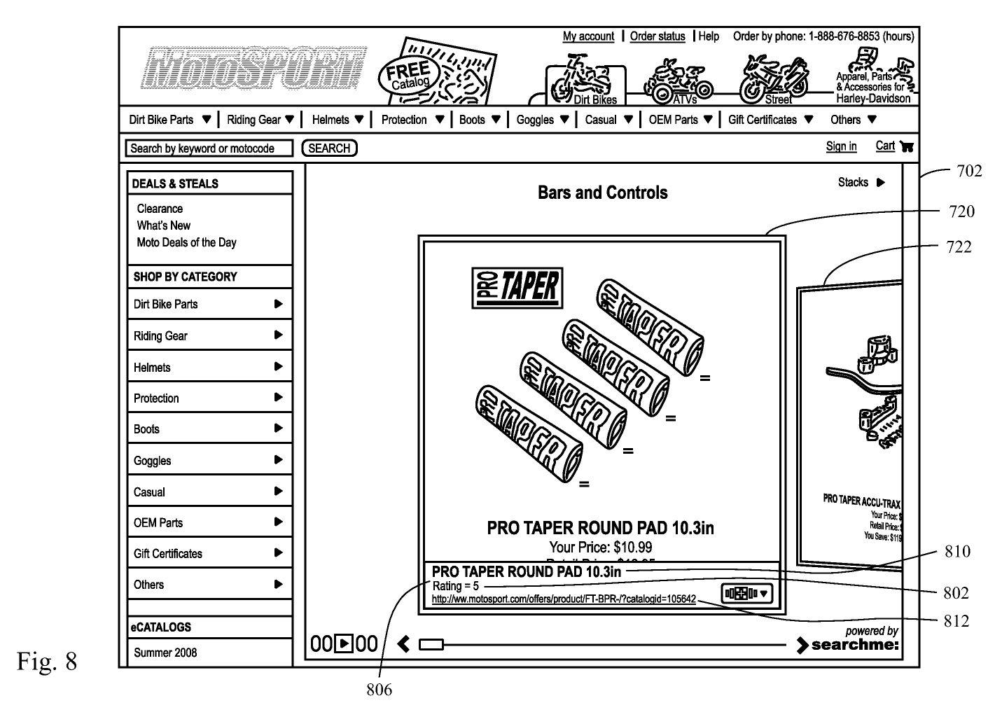

In the exemplary search results schema, there is provided a snippet for each hit. Line 7 illustrates. The snippet for this hit is “Rating=5.” The snippet is encoded in a representation of the hit. When the representation of the hit is displayed by a web browser (e.g., web browser 118 on client 130), the snippet is displayed with the representation under certain conditions. FIG. 8 illustrates the snippet in the representation that corresponds to line 7 of the exemplary search results schema. The snippet “Rating=5” is illustrated as element 802 of panel 806 of web page 702 in FIG. 8. Panel 806 is displayed in this embodiment when the user places a mouse indicator over the bottom portion of web page 702.

In the exemplary search results schema, there is provided a title for each hit. Line 8 of the code below illustrates. The title for this hit is “PRO TAPER ROUND PAD 10.3in.” The title is associated with a representation of the hit. When the representation of the hit is displayed by a web browser, the title is also displayed. FIG. 8 illustrates a title that corresponds to line 8 of the exemplary search results schema. Specifically, the title “PRO TAPER ROUND PAD 10.3in” is illustrated as element 810 in panel 806 of web page 702 in FIG. 8.

In the exemplary search results schema below, there is provided a URL where the results details layout schema for a hit can be found. Lines 17-18 of the exemplary code for the search results schema disclose one such URL. In the exemplary search results schema, there is also provided a URL where the user will be directed to if the representation of the hit, displayed in a web browser, is selected. Lines 9-14 of the exemplary code below for the search results schema disclose one such URL. This URL is displayed in panel 806 of web page 702 in FIG. 8 as element 812.

| | |
|---|---|
| 1 | <?xml version=“1.0” encoding=“UTF-8”?> |
| 2 | <results |
| 3 | nextDataSetURL=“www.domain.com/folder/stackContent.xml”> |
| 4 | <stackName>Helmets</stackName> |
| 5 | |
| 6 | <hit> |
| 7 | <snippet>Rating =5 <BR></snippet> |
| 8 | <title>PRO TAPER ROUND PAD 10.3in</title> |
| 9 | <url> |
| 10 | <![CDATA[http://www.domain.com/folder//product/20 |
| 11 | 07-ARAI-REPLICA-HELMET- |
| 12 | NARITA/?catalogId=100440&refine=1&sBrand |
| 13 | =Arai&srchHistoryURL=3i6p44ap]]> |
| 14 | </url> |
| 15 | <recordType>sdt</recordType> |
| 16 | <renderer>dummyTest</renderer> |
| 17 | <contentUrl>www.domain.com/folder/content2.xml</content |
| 18 | Url> |
| 19 | </hit> |
| 20 | |
| 21 | |
| 22 | <hit> |
| 23 | <snippet>Your Price: $469.99 <BR> Retail Price: |
| 24 | $589.94 <BR> You Save: $119.95 (21%) <BR></snippet> |
| 25 | <title>2008 ARAI REPLICA HELMET - WINGFLAME</title> |
| 26 | <url> |
| 27 | <![CDATA[http://www.domain.com/folder//product/20 |
| 28 | 08-ARAI-REPLICA-HELMET- |
| 29 | WINGFLAME/?catalogId=110506&refine=1&sBrand |
| 30 | =Arai&srchHistoryURL=3i6p44ap]]> |
| 31 | </url> |
| 32 | <recordType>sdt</recordType> |
| 33 | <renderer>dummyTest</renderer> |
| 34 | <contentUrl>www.domain.com/folder/content1.xml</content |
| 35 | Url> |
| 36 | </hit> |
| 37 | |
| 38 | <hit> |
| 39 | <snippet>Snippet stuff here</snippet> |
| 40 | <title>2007 ARAI REPLICA HELMET - MILLSPACE</title> |
| 41 | <url> |
| 42 | <![CDATA[http://www.domain.com//dirtbike/product/ |
| 43 | 2008-ARAI-REPLICA-HELMET- |
| 44 | MILLSAP/?catalogId=100457&refine=1&sBrand |
| 45 | =Arai&srchHistoryURL=3i6p44ap]]> |
| 46 | </url> |
| 47 | <recordType>sdt</recordType> |
| 48 | <renderer>dummyTest</renderer> |
| 49 | <contentUrl>www.domain.com/folder/content3.xml</content |
| 50 | Url> |
| 51 | </hit> |
| 52 | |
| 53 | |
| 54 | <hit> |
| 55 | <snippet>Snippet stuff here</snippet> |
| 56 | <title>2007 ARAI REPLICA HELMET - NARITA</title> |
| 57 | <url> |
| 58 | <![CDATA[http://www.domain.com/folder//product/20 |
| 59 | 07-ARAI-REPLICA-HELMET- |
| 60 | NARITA/?catalogId=100440&refine=1&sBrand |
| 61 | =Arai&srchHistoryURL=3i6p44ap]]> |
| 62 | </url> |
| 63 | <recordType>sdt</recordType> |
| 64 | <renderer>dummyTest</renderer> |
| 65 | <contentUrl>www.domain.com/folder/content2.xml</content |
| 66 | Url> |
| 67 | </hit> |
| 68 | |
| 69 | |
| 70 | <hit> |
| 71 | <snippet>Snippet stuff here</snippet> |
| 72 | <title>2008 ARAI REPLICA HELMET - WINGFLAME</title> |
| 73 | <url> |
| 74 | <![CDATA[http://www.domain.com/folder//product/20 |
| 75 | 08-ARAI-REPLICA-HELMET- |
| 76 | WINGFLAME/?catalogId=110506&refine=1&sBrand |
| 77 | =Arai&srchHistoryURL=3i6p44ap]]> |
| 78 | </url> |
| 79 | <recordType>sdt</recordType> |
| 80 | <renderer>dummyTest</renderer> |
| 81 | <contentUrl>www.domain.com/folder/content1.xml</content |
| 82 | Url> |
| 83 | </hit> |
| 84 | |
| 85 | <hit> |
| 86 | <snippet>Snippet stuff here</snippet> |
| 87 | <title>2007 ARAI REPLICA HELMET - MILLSPACE</title> |
| 88 | <url> |
| 89 | <![CDATA[http://www.domain.com//dirtbike/product/ |
| 90 | 2008-ARAI-REPLICA-HELMET- |
| 91 | MILLSAP/?catalogId=100457&refine=1&sBrand |
| 92 | =Arai&srchHistoryURL=3i6p44ap]]> |
| 93 | </url> <recordType>sdt</recordType> |
| 94 | <renderer>dummyTest</renderer> |
| 95 | <contentUrl>www.domain.com/folder/content3.xml</content |
| 96 | Url> |
| 97 | </hit> |
| 98 | </results> |

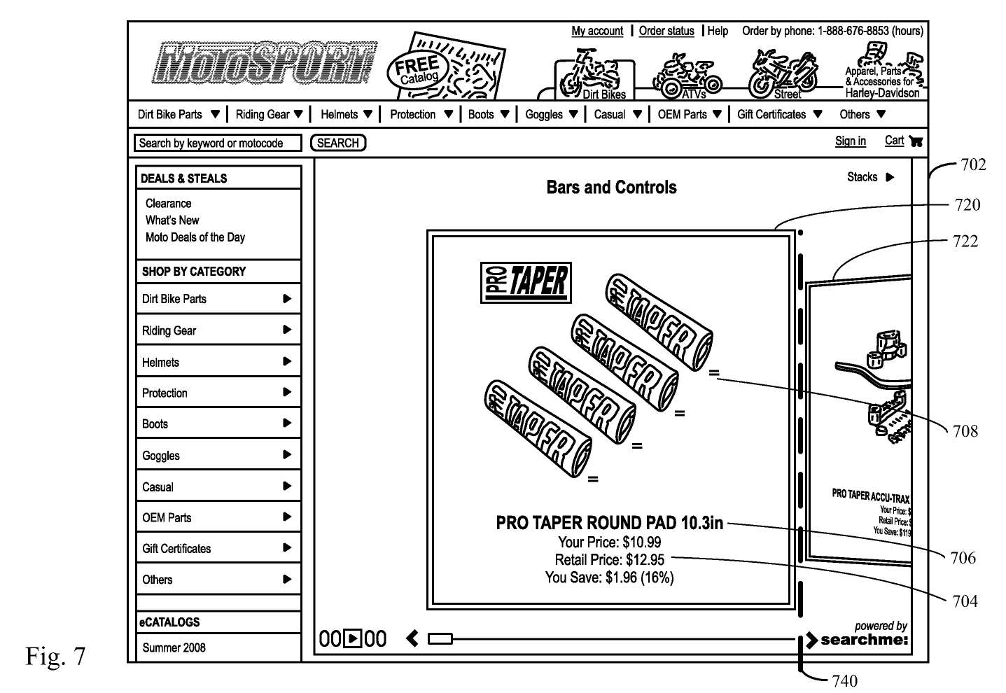

The following exemplary code is an example of a result details layout schema for the hit (search result) described by lines 6-19 of the exemplary code for the search results schema above. Text specified at lines 27-39 of the exemplary code below is displayed as element 706 in the representation of the hit in web page 702 illustrated in FIG. 7. Text specified at lines 15-26 of the exemplary code below is displayed as element 704 in the representation of the hit in web page 702. The image specified at lines 6-14 of the exemplary code below is displayed as image 708 in the representation of the hit web page 702.

| | |
|---|---|
| 1 | <?xml version=“1.0” encoding=“UTF-8”?> |
| 2 | <content |
| 3 | id=“dummyTest” |
| 4 | size=“400” |
| 5 | backgroundColor=“#ffffff”> |
| 6 | <image |
| 7 | align=“center” |
| 8 | y=“20” |
| 9 | multiline=“false” |
| 10 | selectable=“false” |
| 11 | sourceURL=“http://www.domain.com/folder/images/ |
| 12 | helmet_med.jpg” width=“275” |
| 13 | height=“257” |
| 14 | /> |
| 15 | <text |
| 16 | align=“center” |
| 17 | y=“270” |
| 18 | width=“400”> |
| 19 | <font |
| 20 | size=“14” |
| 21 | color=“#CC0000” |
| 22 | face=“Arial, Helvetica, sans-serif”> |
| 23 | <b>Your Price $10.99</b> <b>Retail Price |
| 24 | $12.95</b> <b>You Save $1.96</b> |
| 25 | </font> |
| 26 | </text> |
| 27 | <text |
| 28 | align=“center” |
| 29 | y=“290” |
| 30 | multiline=“false” |
| 31 | selectable=“false” |
| 32 | width=“400”> |
| 33 | <font |
| 34 | size=“14” |
| 35 | color=“#000000” |
| 36 | face=“Arial, Helvetica, sans-serif”> |
| 37 | <b>PRO TAPER ROUND PAD 10.3in</b> |
| 38 | </font> |
| 39 | </text> |
| 40 | <image |
| 41 | x=“172” |
| 42 | y=“340” |
| 43 | sourceURL=“http://www.domain.com/folder/images/rating.gif” |
| 44 | |
| 45 | /> |
| 46 | </content> |

In step 312, dynamic web page processing script 190 uses the search result schema and the result details layout schemas to rebuild web page 188 (e.g., create a second web page). As part of this process, code, such as the exemplary code below is incorporated into the rebuilt web page.

| | |
|---|---|
| 1 | <object classid=“clsid:D27CDB6E-AE6D-11cf-96B8-444553540000” |
| 2 | id=“embedded” width=“900” height=“400” |
| 3 | codebase=“http://fpdownload.macromedia.com/get/flashplayer/ |
| 4 | current/swflash.cab”> |
| 5 | <param name=“flashvars” |
| 6 | value=“autoPlay=false&theme=white&stackContentURL=http:// |
| 7 | www.foo.com/pathToFirst10Results.xml” |
| 8 | /> |
| 9 | |
| 10 | <param name=“movie” value=“http://www.searchme.com/ |
| 11 | embed?v=1&a=sp” /> |
| 12 | <param name=“quality” value=“high” /> |
| 13 | <param name=“bgcolor” value=“#FFFFFF” /> |
| 14 | <param name=“allowScriptAccess” value=“always” /> |
| 15 | <param name=“allowFullScreen” value=“true” /> |
| 16 | <embed |
| 17 | src=“ http://www.searchme.com/embed?v=1&a=sp” |
| 18 | quality=“high” |
| 19 | bgcolor=“#FFFFFF” |
| 20 | width=“900” |
| 21 | height=“400” |
| 22 | name=“embedded” |
| 23 | align=“middle” |
| 24 | play=“true” |
| 25 | loop=“false” |
| 26 | quality=“high” |
| 27 | allowScriptAccess=“always” |
| 28 | type=“application/x-shockwave-flash” |
| 29 | flashvars=“autoPlay=false&theme=white&stackContentURL= |
| 30 | http://www.foo.com/pathToFirst10Results.xml” |
| 31 | allowFullScreen=“true” |
| 32 | plug-inspage=“http://www.adobe.com/go/getflashplayer”> |
| 33 | </embed> |
| 34 | </object> |

In the exemplary code above, lines 1-15 are interpreted by an Internet Explorer web browser when the rebuild web page is loaded by such a browser whereas lines 16 through 33 are interpreted by the FIREFOX web browser when loaded by such a browser. Line 2 of the code defines a window in the rebuilt web page having a specified width and height. The representations or products and/or services that match the user query are displayed in this window. In some embodiments, the window is an HTML IFRAME. Advantageously, the product/service provider can adjust the size and width of this window by modifying the width and height parameters in line 2 of the exemplary code above. Lines 3-4 of the exemplary code provides the location on page flow/stack server 154 of a page flow module 154 for interpreting the search results schema and result details layout schema, building representations of products or services contain in these schemas, and visualizing the representations in the web page. Lines 5-7 of the exemplary code contain parameters that are used by the page flow module 154. These parameters include the customization parameters “autoplay” which determines if representations scroll without user intervention, a color code scheme, and the location of the search results schema on product/service server 198. Lines 12-15 are Internet Explorer specific parameters. In some embodiments, page flow module 154 is based on the FLASH programming language.

In step 314, the web page, with the exemplary code incorporated, is served to client 130.

Referring to FIG. 8, some of the advantages of the present invention can now be appreciated. FIG. 8 shows a results web page that includes a first representation 720 of a first search result. The first representation 720 is specified, in part, by the search results schema (e.g., panel 806 in representation 720) and, in part, by a first result details layout schema (e.g., the upper portion of representation 720) in a plurality of result details layout schemas. However, as described in step 312 above, all the product/service provider 198 had to do was (i) build or retrieve the search results schema, (ii) build or retrieve the result details layout schema, and (iii) incorporate code into the rebuild web page (e.g., second web page) that calls the page flow module 148 and specifies the location of the search results schema. In this way, the product/service provider (e.g., a merchant) is able to provide details of products/services in a highly advantageous manner without complex coding. Furthermore, because of the advantageous predefined formats of the search results schema and the result details layout schemas, in which representations of products or services are rendered based, in part, on by the search results schema and, in part, by result details layout schemas, up to date product service information can be easily maintained by the product/service provider. This maintenance requires minimal effort on the part of the product/service provider. By simply keeping the search results schema and the result details layout schemas current, the product/service provider can maintain an up to date on line catalog or product/services if desirable.

Returning to FIG. 3, in step 316, web browser 118 interprets the web page 188 sent to the client 130 in step 314 and, in so doing, parses the instructions in the web page to call page flow module 148 on page flow/stack server 154 in order to obtain page flow module 148. In step 318, in response to request 316, page flow/stack server 154 serves the module to client 130. Page flow module 148 accesses the search results schema using the path specified in web page 188. Page flow module 148 accesses the plurality of result details layout schemas using the path specified for each of these schemas in the search results schema. Page flow module 148 builds a representation for each respective hit in the search results schema based, in part, on information for the respective hit in the search results schema and based, in part, on information for the respective hit in the search results schema that corresponds to the respective hit. These representations are displayed in a portion of the web page. In some embodiments, this portion of the web page is an IFRAME having boundaries specified by line 2 of the exemplary code incorporated into the web page during step 312 of FIG. 3. An example of a representation is representation 720 in FIG. 8.

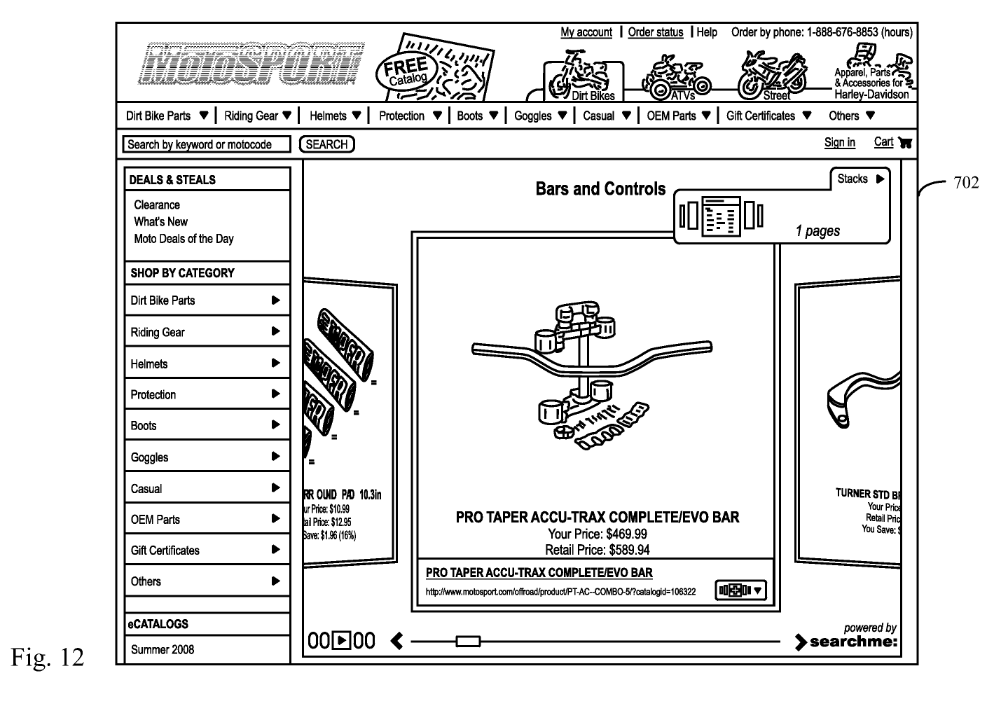

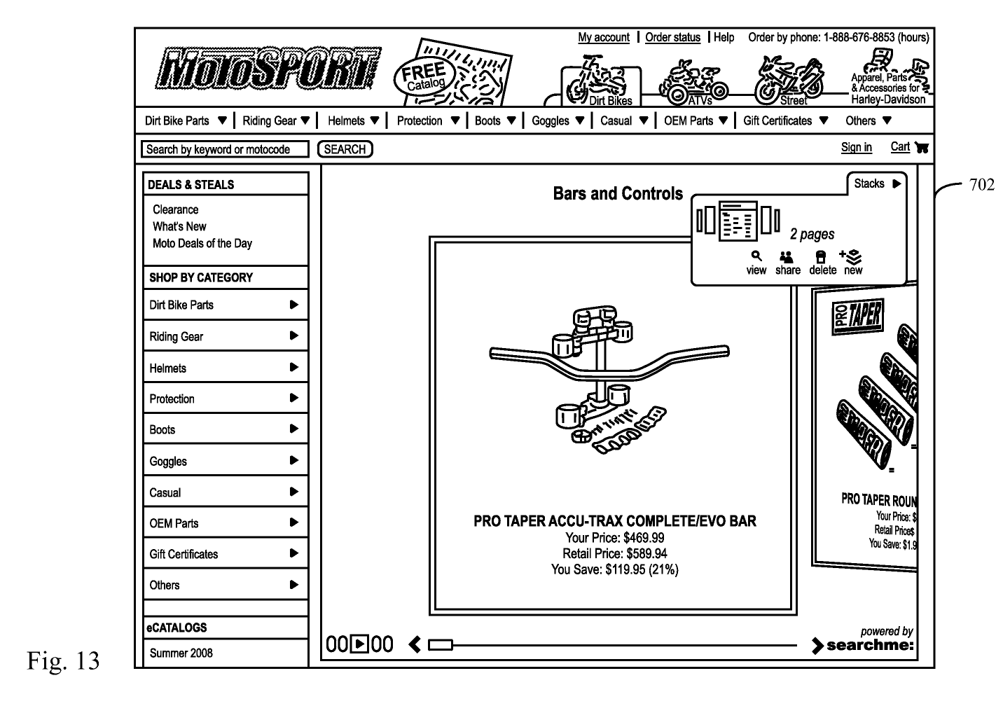

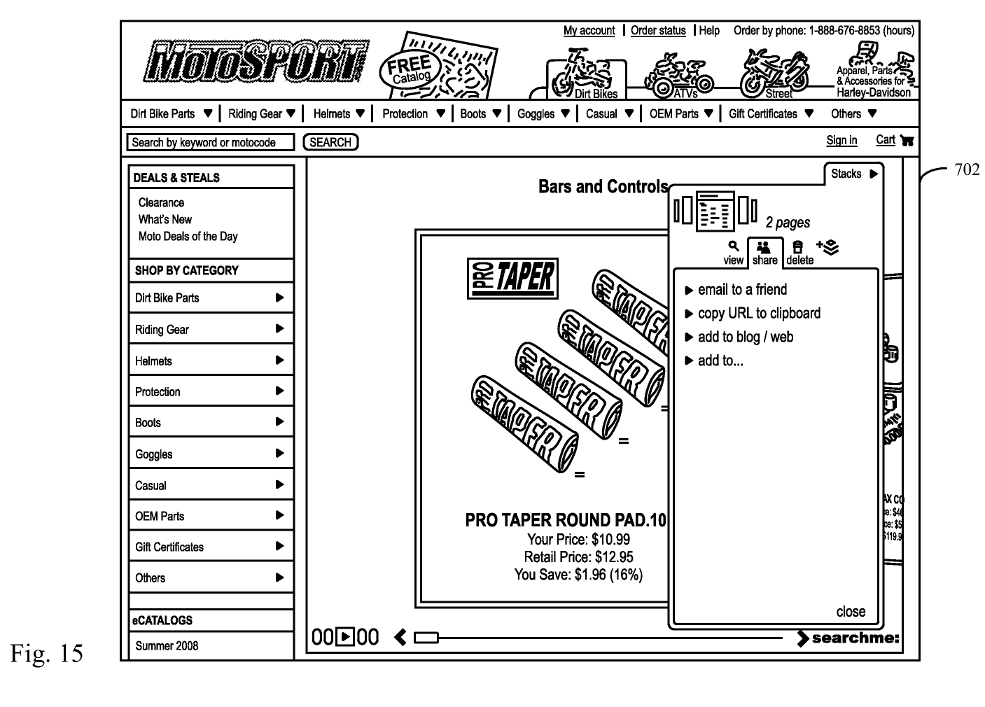

Optionally, in step 320, responsive to the rebuilt web page (e.g., second web), a check is performed to determine whether there is any stack identifiers 122 associated with a user of the client device 130. For example, such stack identifiers 122 can be in the form of a cookie or other data structure that is stored in memory 114 and/or memory 104 of the client 130. If stacks (albums) are found, in step 322, client 130 queries stack database 152 for these stacks. In step 324, responsive to such a request, web server 146 execute stack query module 150 to retrieve all or a portion of each requested stack from stack database 152. In step 326, which is reached regardless of whether steps 320, 322, or 324 is executed, a user review search results in a page flow format illustrated in FIGS. 7 through 16 with an option to place specified search results into one or more stacks associated with a user.

In some embodiments, steps 320 and 322 are performed by product/service server 198 instead of by client 130. Furthermore, more generally, because page flow/stack server 154, client 130, and product/service 198 are each connected by Internet or other network 160, it will be appreciated that all or a portion of any of the steps disclosed in FIG. 3 can be performed on any one of the page flow/stack server 154, client 130, or product/service server 198. FIG. 3 and FIG. 1 merely disclose one configuration for performing such steps that has been found to optimal because it allows a merchant with a web page to implement the features disclosed herein in a quick and efficient manner.

As illustrated in FIG. 7, the second (rebuilt) web page 702 that is sent to client 130 in step 318 comprises instructions for encoding a first representation 720 of a first search result in the plurality of search results in a center position of the second web page 702, where the first representation 720 is specified by the search results schema and a first result details layout schema in the plurality of result details layout schemas of step 310. Furthermore, the second (rebuilt) web page 702 that is sent to client 130 in step 318 comprises instructions for encoding a second representation 722 of a second search result in the plurality of search results in a first off-center position of the second web page 702 relative to the first representation, where the second representation 722 is rotated about a first axis of rotation 740 that lies between the center position and the first off-center position of the second web page 702. The second representation 722 is specified by the search results schema and a second result details layout schema in the plurality of result details layout schemas of step 310.

FIG. 8 illustrates a computer readable interface for distributing and maintaining product or service information in accordance with an exemplary embodiment in which a description of a first search result 802, a title of a first search result 810, and a URL 812 that contains more information about a first search result is displayed when a user mouses over a portion 806 of a representation 720 of a first search result.

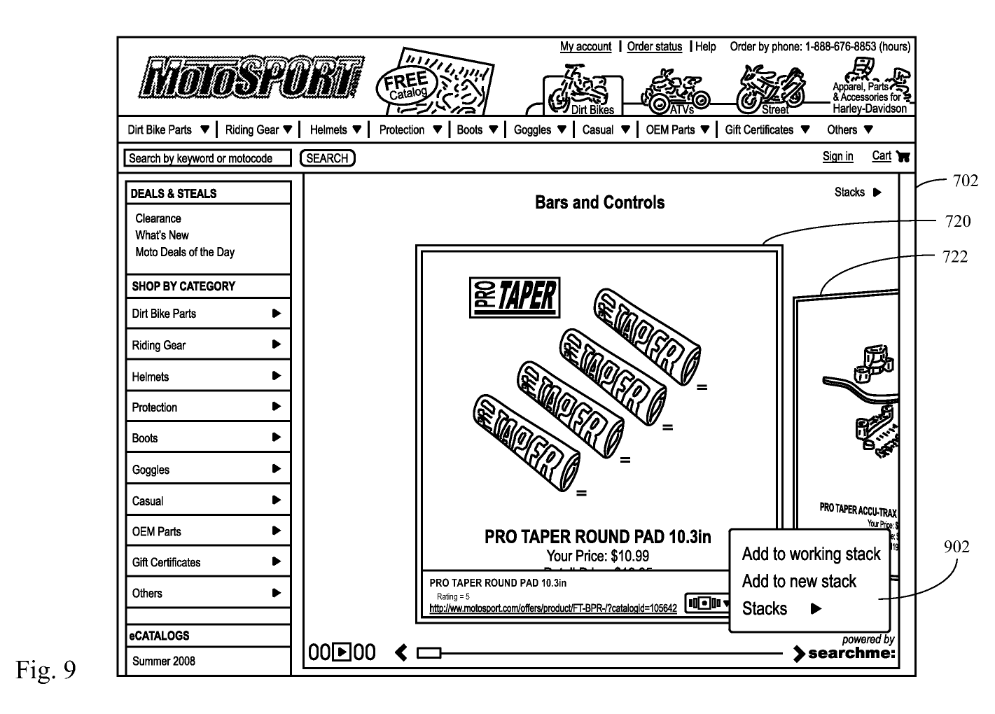

FIG. 9 illustrates a computer readable interface for distributing and maintaining product or service information in accordance with an exemplary embodiment in which an option 902 to add a representation 720 of a first search result to a working stack (album) or a new stack is provided.

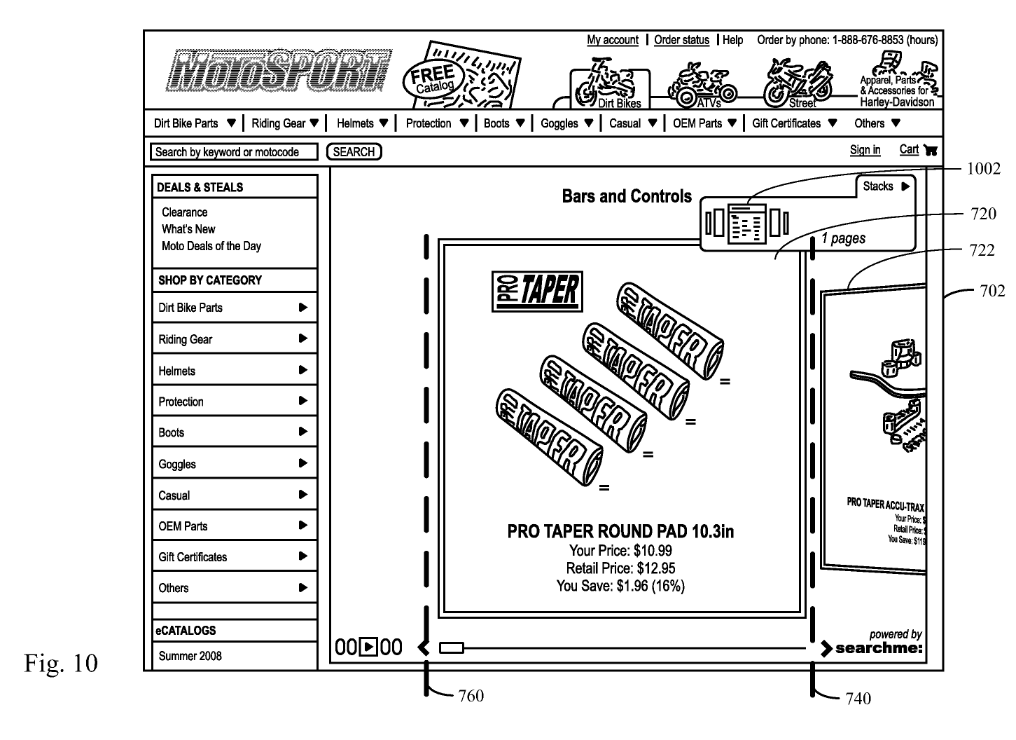

FIG. 10 illustrates a computer readable interface for distributing and maintaining product or service information in accordance with an exemplary embodiment in which a first search result has been added to a stack 1002.

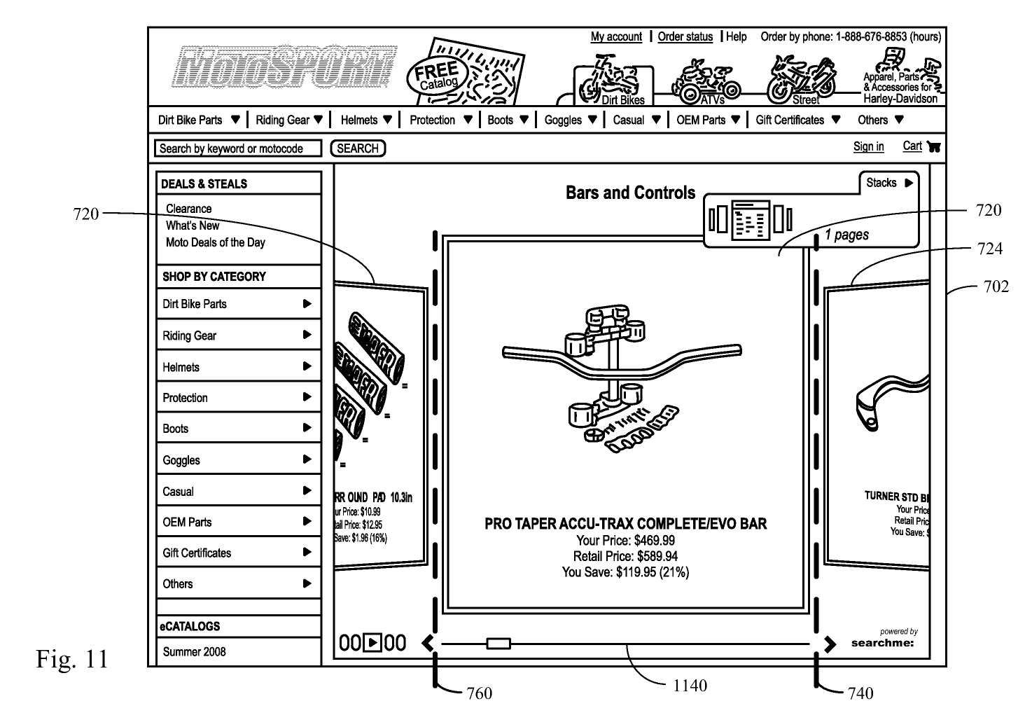

Referring to FIGS. 10 and 11, in some embodiments, the second web page 702 comprises instructions, responsive to a selection of the second representation 722 in the first off-center position when the second web page 702 is in the state illustrated in FIG. 10, for

(i) shifting the first representation 720 to a second off-center position of said second web page 702 thereby causing the first representation 720 to be displayed at the second off-center position rotated about a second axis of rotation 760 that lies between the center position and the second off-center position of the second web page 702,

(ii) shifting the second representation 722 to the center position of the second web page 702, thereby causing the second representation 722 to be displayed at the center position in a manner that is no longer rotated about the first axis of rotation 740, and

(iii) displaying a third representation 724 of a third search result in the plurality of search results in the first off-center position of the second web page 702, wherein the third representation is rotated about the first axis of rotation 740 and wherein the third representation 724 is specified by the search results schema and a third result details layout schema in the plurality of result details layout schemas from step 310, thereby achieving the state illustrated in FIG. 11.

The state of web page 702 illustrated in FIG. 10 can be achieved by selecting the first representation 720 (e.g., clicking on the first representation) when the web page 702 is in the state illustrated in FIG. 11. As such, in some embodiments, responsive to a selection of the first representation 720 in the second off-center position, the computer-executed method further comprises:

shifting the first representation 720 to the center position of the second web page 702 thereby causing the first representation to be displayed at the center position in a manner that is no longer rotated about the second axis of rotation, and

shifting the second representation 722 to the first off-center position thereby causing the second representation 722 to be displayed at the first off-center position in a manner that is rotated about the first axis of rotation, thereby achieving the state for web page 702 illustrated in FIG. 11.

Referring to FIG. 8, in some embodiments, the second web page 702 further comprises instructions, responsive to mousing over a bottom portion 806 of the first representation 720 and thereby revealing a URL 812, for linking to the URL 812 specified by code corresponding to the first search result corresponding to the first representation 720 in the search results schema from step 310, when the user selects the URL 812. Referring to FIG. 7, in some embodiments, the second web page further comprises instructions, responsive to a selection of the first representation 720, for linking to a URL specified by code corresponding to the first search result in the search results schema from step 310.

Referring to FIG. 8, in some embodiments, the second web page 702 further comprises instructions, responsive to a selection of a bottom portion 806 of the representation 720, for displaying a description (802) of the first search result corresponding to the first representation 720, a title 810 of the first search result, and a URL 812 that contains more information about the first search result corresponding to the first representation 720.

Referring to FIG. 11, in some embodiments, the second web page 702 further comprises instructions for providing a toggle bar 1140 with the second web page 702 so that (i) when a search requester pulls the toggle bar 1140 in a first direction (e.g., to the left), a representation of a search result in the plurality of search results shifts from the first off-center position to the center position, and from the center position to a second off-center position responsive to the pull in the first direction, and (ii) when the search requester pulls the toggle bar in a second direction (e.g., to the right), a representation of a search result in the first plurality of search results shifts from the second off-center position to the center position, and from the center position to the first off-center position responsive to the pull in the second direction.

Referring to FIG. 10, in some embodiments, a selection is made of (i) a search result in the plurality of search results (e.g., by selection of a representation such as representation 720) and (ii) a selection of an album 1002 stored on a remote computer (e.g., stored in stack database 152 of page flow/stack server 154), where the album comprises a plurality of records (e.g., links 296), each record comprising an address of a document or a data structure, is made. In some such embodiments, responsive to such selections, a location of an image for the selected search result from the hit description for the selected search result in the search results schema is identified and added to a record (line 298) in the album stored on the remote computer, where the record comprises the location of the image.

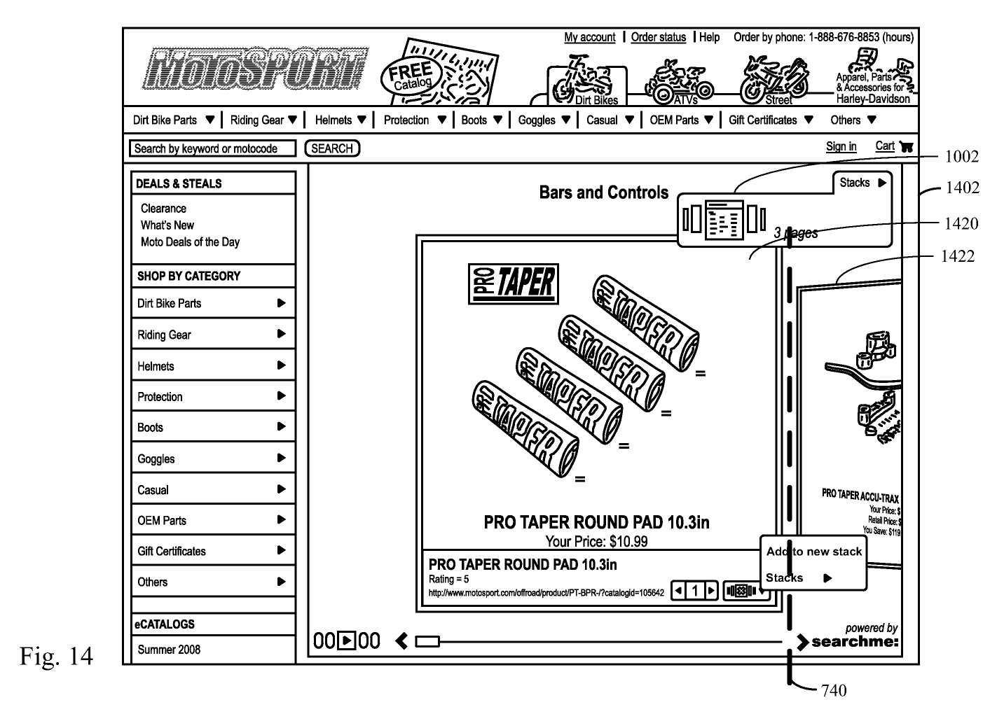

Referring to FIG. 14, in some embodiments, a request to view a stack 1002 is made. In such embodiments, responsive to this request, a third web page 1402 is created. The third web page comprises instructions for (i) encoding a first image 1420 of a first document or a first data structure addressed by a first record in the plurality of records (links) 296 in the album 280 in a center position of the third web page 1402, and encoding a second image 1422 of a second document or a second data structure addressed by a second record 296 in the plurality of records in a first off-center position of the third web page 1402 relative to the first image, where the second image is rotated about a first axis of rotation 1440 that lies between the center position and the first off-center position of the third web page 1402.

Advantageously, links 296 added to an album 280 from the search results identified by the methods disclosed herein, for example, the method disclosed in FIG. 3, can be shared as standard links in a stack (album) 280. Even more advantageously, each time such links are viewed by end-users (.e.g., users of client devices 130), information in such links can be updated. For example, the product availability or pricing can be updated. Thus, advantageously, in some embodiments, the links 296 added to a stack 280 using the methods disclosed herein can include access to a database entry in product/services database 194 that includes up to date information on the product. In this manner, very powerful wish lists can be generated by adding links 296 from one or more different web sites, such as web site 702 to a stack 280 and sharing the stack with other users. Accordingly, in some embodiments, referring to FIG. 14, an image 1420 in a stack 280 was added from a search such as the search disclosed in FIG. 3. Moreover, the image 1420 is modified between (i) a time when the location of the image 1420 is added to a record (link) 296 in the album 280 and (ii) a time when the first image is viewed in the manner depicted in FIG. 14. Between time (i) and (ii) the album 280 may be shared to another user and the viewing that is done in FIG. 14 may be done on a client device 130 other than the client device 130 that was used to added the image 1420 to the album 280 in the first instance. In some embodiments, the updating of the image is performed to provide and updated price or availability for a product or a service.

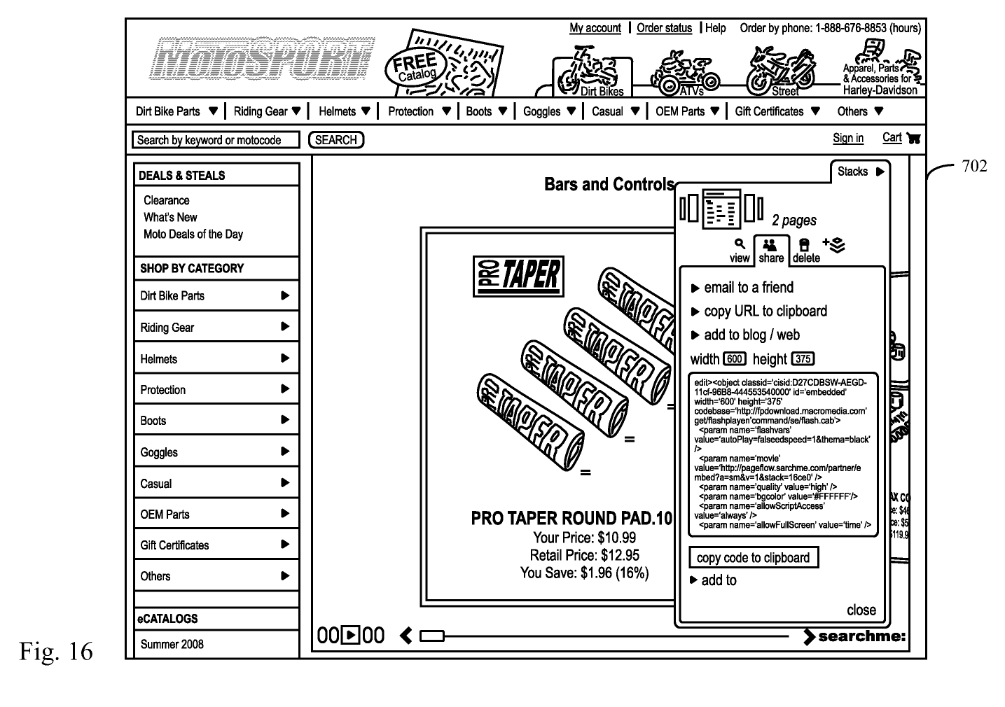

Referring to FIG. 16, stacks 280 can be shared. For example, in some embodiments, a request to share an album (stack 280) with a party associated with a third remote computer is received. Responsive to the request, a link to the album stored in the remote location is formed and an invitation to view the album is sent to a remote computer, where the invitation comprises the link.

Another aspect provides a computer program product for use in conjunction with a computer system, the computer program product comprising a computer readable storage medium and a computer program mechanism embedded therein, the computer program mechanism comprising instructions for performing any of the methods disclosed herein.

Another aspect provides a computer, comprising a main memory, one or more processors, and one or more programs, stored in the main memory and executed by the one or more processors, the programs collecting including instructions for performing any of the methods disclosed herein.

All references cited herein are incorporated herein by reference in their entirety and for all purposes to the same extent as if each individual publication or patent or patent application was specifically and individually indicated to be incorporated by reference in its entirety for all purposes.

The systems and methods described herein can be implemented as a computer program product that includes a computer program mechanism embedded in a computer readable storage medium. For example, the computer program product can contain the program modules shown in FIG. 1. These program modules can be stored on a CD-ROM, DVD, magnetic disk storage product, or any other computer readable data or program storage product.

Many modifications and variations of this invention can be made without departing from its spirit and scope, as will be apparent to those skilled in the art. The specific embodiments described herein are offered by way of example only. The embodiments were chosen and described in order to explain the principles of the invention and its practical applications, to thereby enable others skilled in the art to utilize the invention and various embodiments with various modifications as are suited to the particular use contemplated. The invention is to be limited only by the terms of the appended claims, along with the full scope of equivalents to which such claims are entitled.

What is claimed:

1. A computer-executed method comprising:
(A) receiving a query for a first web page;
(B) providing said first web page in response to said query to a first remote computer, wherein said first web page includes instructions for prompting a user for a product or service query;
(C) receiving a product or service query responsive to said providing (B);
(D) searching for one or more products or one or more services in a database that matches said product or service query thereby obtaining a plurality of search results;
(E) generating or retrieving a search results schema for said plurality of search results, wherein the search results schema comprises a hit description for all or a portion of the search results in said plurality of search results;
(F) generating or retrieving a plurality of result details layout schemas, wherein each result details layout schema in said plurality of result details layout schemas corresponds to a search result in said plurality of search results, and wherein the search results schema specifies a location for each result details layout schema in all or the portion of the plurality of result details layout schemas; and
(G) creating a second web page, wherein said second web page comprises instructions for encoding a first representation of a first search result in said plurality of search results wherein the first representation is specified, in part, by the search results schema and, in part, by a first result details layout schema in said plurality of result details layout schemas.

2. The computer-executed method of claim 1, wherein the second web page further comprises:
instructions for encoding said first representation in a first position of said second web page, and
instructions for encoding a second representation of a second search result in said plurality of search results in a second position of said second web page, wherein the second representation is specified, in part, by the search results schema and, in part, by a second result details layout schema in said plurality of result details layout schemas.

3. The computer-executed method of claim 2, wherein
the first position is a center position of said second web page,
the second position is a first off-center position of said second web page, and
the second representation is rotated about a first axis of rotation that lies between the center position and the first off-center position of the second web page.

4. The computer-executed method of claim 1, wherein the search results schema comprises a description of a first search result in said plurality of search results, a title of the first search result, and a URL that a user will be directed to when the user selects the first search result.

5. The computer-executed method of claim 1, wherein the first result details layout schema comprises a size and a background color of said first representation.

6. The computer-executed method of claim 1, wherein the first result details layout schema comprises:
text describing the first search result and a position that the text is to be placed in the first representation or
an image describing the first search result and a position that the image is to be placed in the first representation.

7. The computer-executed method of claim 2, wherein said second web page further comprises instructions, responsive to a selection of the second representation in the first off-center position, for:
shifting the first representation to a second off-center position of said second web page thereby causing the first representation to be displayed at the second off-center position rotated about a second axis of rotation that lies between the center position and the second off-center position of the second web page;
shifting the second representation to the center position of the second web page, thereby causing the second representation to be displayed at the center position in a manner that is no longer rotated about the first axis of rotation; and
displaying a third representation of a third search result in said plurality of search results in said first off-center position of said second web page, wherein the third representation is rotated about said first axis of rotation and wherein the third representation is specified, in part, by the search results schema and, in part, by a third result details layout schema in said plurality of result details layout schemas.

8. The computer-executed method of claim 7 wherein, responsive to a selection of the first representation in the second off-center position, said second web page further comprises instructions for:
shifting the first representation from the second off-center position to the center position of the second web page thereby causing the first representation to be displayed at the center position in a manner that is no longer rotated about the second axis of rotation; and
shifting the second representation from the center position to the first off-center position thereby causing the second representation to be displayed at the first off-center position in a manner that is rotated about the first axis of rotation.

9. The computer-executed method of claim 1, wherein the second web page further comprises instructions, responsive to a selection of the first representation, for linking to a URL specified by code corresponding to the first search result in the search results schema.

10. The computer-executed method of claim 1, wherein the second web page further comprises instructions, responsive to a selection of the first representation, for displaying a description of said first search result, a title of the first search result, and a URL that contains more information about the first search result.

11. The computer-executed method of claim 2, wherein the second web page further comprises instructions for providing a toggle bar with the second web page so that,
when a search requester pulls the toggle bar in a first direction, a representation of a search result in the plurality of search results shifts from the first off-center position to the center position, and from the center position to a second off-center position responsive to the pull in the first direction; and
when a search requester pulls the toggle bar in a second direction, a representation of a search result in the first plurality of search results shifts from the second off-center position to the center position, and from the center position to the first off-center position responsive to the pull in the second direction.

12. The computer-executed method of claim 1, the computer-executed method further comprising:
(H) receiving a selection of (i) a selected search result in said plurality of search results and (ii) an identification of an album stored on a second remote computer, wherein the album comprises a plurality of records, each record comprising an address of a document or a data structure; and
(I) performing, responsive to the receiving (H), a computer-executed method comprising:
(i) obtaining a location of an image for the selected search result from the hit description for the selected search result in the search results schema, and
(ii) adding a record to the album stored on the second remote computer, wherein the record comprises the location of the image.

13. The computer-executed method of claim 12, the method further comprising:
(J) receiving a request to review the album; and
(K) creating, responsive to the receiving (J), a third web page, wherein said third web page comprises instructions for:
encoding a first image of a first document or a first data structure addressed by a first record in the plurality of records in the album in a center position of said third web page, and
encoding a second image of a second document or a second data structure addressed by a second record in the plurality of records in a second position of said third web page relative to the first image

14. The computer-executed method of claim 13, wherein the second image is rotated about a first axis of rotation that lies between the center position and the first off-center position of the third web page.

15. The computer-executed method of claim 13, wherein the first image or the second image is the image for the selected search added to the album by the performing (I).

16. The computer-executed method of claim 13, wherein the first image is the image for the selected search added to the album by the performing (I) and wherein the first image is modified between
(i) a time when the location of the image for the selected search result is added to a record in the album by the performing (I), and
(ii) a time when the creating (K) encodes the first image.

17. The computer-executed method of claim 13, wherein the first image is modified between
(i) a time when the location of the image for the selected search result is added to a record in the album by the performing (I), and
(ii) a time when the creating (K) encodes the first image in order to include an updated price or availability for a product or a service.

18. The computer-executed method of claim 13, wherein
a record in the plurality of records is a link is to a static graphic representation stored in a document repository in a remote location,
the static graphic representation is a static graphic representation of a document retrieved from the Internet at a time before the receiving (A).

19. The computer-executed method of claim 12, the computer-executed method further comprising:
(J) receiving a request to share the album with a party associated with a third remote computer, and
(K) performing, responsive to the request, a computer-executed method comprising:
(i) forming a link to the album stored in the remote location, and
(ii) causing an invitation to view the album to be sent to the third remote computer, wherein the invitation comprises the link.

20. A computer program product for use in conjunction with a computer system, the computer program product comprising a computer readable storage medium and a computer program mechanism embedded therein, the computer program mechanism comprising instructions for performing the computer-executed method of claim 1.

21. A computer, comprising:
a main memory;
one or more processors; and
one or more programs, stored in the main memory and executed by the one or more processors, the programs collecting including instructions for performing the computer-executed method of claim 1.

22. A computer-executed method comprising:
(A) sending a query for a first web page using an Internet browser;
(B) displaying a first web page received from a first remote computer in response to said query, wherein said first web page includes instructions for prompting a user for a product or service query;
(C) sending, responsive to said displaying (B), a product or service query; and
(D) displaying a second web page using an information construct, wherein
the information construct comprises a search results schema or is derived from the search results schema,
the search results schema comprises a hit description for each search result in a plurality of search results for the product or service query, and
a hit description in the search results schema specifies a location of a result details layout schema in a plurality of result details layout schemas, and wherein said second web page comprises instructions for
encoding a first representation of a first search result in said plurality of search results, wherein the first representation is specified, in part, by the search results schema and, in part, by a first result details layout schema in said plurality of result details layout schemas.

23. The computer-executed method of claim 22, wherein the second web page further comprises:
instructions for encoding said first representation in a first position of said second web page, and
instructions for encoding a second representation of a second search result in said plurality of search results in a second position of said second web page, wherein the second representation is specified, in part, by the search results schema and, in part, by a second result details layout schema in said plurality of result details layout schemas.

24. The computer-executed method of claim 23, wherein
the first position is a center position of said second web page,
the second position is a first off-center position of said second web page, and
the second representation is rotated about a first axis of rotation that lies between the center position and the first off-center position of the second web page.

25. The computer-executed method of claim 22, wherein the search results schema comprises a description of a first search result in said plurality of search results, a title of the first search result, and a URL that a user will be directed to when the user selects the first search result.

26. The computer-executed method of claim 22, wherein the first result details layout schema comprises a size and a background color of said first representation.

27. The computer-executed method of claim 22, wherein the first result details layout schema comprises:
text describing the first search result and a position that the text is to be placed in the first representation, or
an image describing the first search result and a position that the image is to be placed in the first representation.

28. The computer-executed method of claim 23, wherein said second web page comprises instructions, responsive to a selection of the second representation in the first off-center position, for:
shifting the first representation to a second off-center position of said second web page thereby causing the first representation to be displayed at the second off-center position rotated about a second axis of rotation that lies between the center position and the second off-center position of the second web page;
shifting the second representation to the center position of the second web page, thereby causing the second representation to be displayed at the center position in a manner that is no longer rotated about the first axis of rotation; and
displaying a third representation of a third search result in said plurality of search results in said first off-center position of said second web page, wherein the third representation is rotated about said first axis of rotation and wherein the third representation is specified by the search results schema and a third result details layout schema in said plurality of result details layout schemas.

29. The computer-executed method of claim 28, responsive to a selection of the first representation in the second off-center position, the second web page further comprising instructions for:
shifting the first representation to the center position of the second web page thereby causing the first representation to be displayed at the center position in a manner that is no longer rotated about the second axis of rotation; and
shifting the second representation to the first off-center position thereby causing the second representation to be displayed at the first off-center position in a manner that is rotated about the first axis of rotation.

30. The computer-executed method of claim 23, wherein the second web page further comprises instructions, responsive to a selection of the first representation, for linking to a URL specified by code corresponding to the first search result in the search results schema.

31. The computer-executed method of claim 23, wherein the second web page further comprises instructions, responsive to a selection of the first representation, for displaying a description of said first search result, a title of the first search result, and a URL that contains more information about the first search result.

32. The computer-executed method of claim 23, wherein the second web page further comprises instructions for providing a toggle bar in the second web page so that,
when a search requester pulls the toggle bar in a first direction, a representation of a search result in the plurality of search results shifts from the first off-center position to the center position, and from the center position to a second off-center position responsive to the pull in the first direction; and
when a search requester pulls the toggle bar in a second direction, a representation of a search result in the first plurality of search results shifts from the second off-center position to the center position, and from the center position to the first off-center position responsive to the pull in the second direction.

33. The computer-executed method of claim 22, the computer-executed method further comprising:
(E) receiving a selection of (i) a selected search result in said plurality of search results displayed on the second web page and (ii) an identification of an album, wherein the album comprises a plurality of records, each record comprising an address of a document or a data structure; and
(F) performing, responsive to the receiving (E), a computer-executed method comprising:
(i) obtaining a location of an image for the selected search result from the hit description for the selected search result in the search results schema; and
(ii) adding a record to the album stored, wherein the record comprises the location of the image.

34. The computer-executed method of claim 33, wherein a record in the plurality of records is stored on a remote computer and the receiving (E) comprises obtaining the record from the remote computer.

35. The computer-executed method of claim 33, the computer-executed method further comprising:
(G) receiving a request to review the album; and
(H) dynamically creating, responsive to the receiving (G), a third web page, wherein said third web page comprises instructions for
encoding a first image of a first document or a first data structure addressed by a first record in the plurality of records in the album in a first position of said third web page, and
encoding a second image of a second document or a second data structure addressed by a second record in the plurality of records in a second position of said third web page.

36. The computer-executed method of claim 35, wherein the second image is rotated about a first axis of rotation that lies between the first position and the second position of the third web page.

37. The computer-executed method of claim 35, wherein the first image or the second image is the image for the selected search result added to the album by the performing (F).

38. The computer-executed method of claim 35, wherein the first image is the image for the selected search added to the album by the performing (F) and wherein the first image is modified between
(i) a time when the location of the image for the selected search result is added to a record in the album by the performing (F), and
(ii) a time when the dynamically creating (H) encodes the first image into said third web page.

39. The computer-executed method of claim 35, wherein the first image is the image for the selected search added to the album by the performing (F) and wherein the first image is modified between
(i) a time when the location of the image for the selected search result is added to a record in the album by the performing (F), and
(ii) a time when the dynamically creating (H) encodes the first image in order to include an updated price or availability for a product or a service.

40. The computer-executed method of claim 33, wherein a record in the plurality of records is a link is to a static graphic representation stored in a document repository in a remote location, wherein the static graphic representation is a static graphic representation of a document retrieved from the Internet at a time before the sending (A).

41. The computer-executed method of claim 33, the computer-executed method further comprising:
(G) receiving a request to share the album with a party associated with a remote computer; and
(H) performing, responsive to the request, a computer-executed method comprising:
(i) forming a link to the album stored in the remote location; and
(ii) causing an invitation to view the album to be sent to the remote computer, wherein the invitation comprises the link.

42. A computer program product for use in conjunction with a computer system, the computer program product comprising a computer readable storage medium and a computer program mechanism embedded therein, the computer program mechanism comprising instructions for performing the computer-executed method of claim 22.

43. A computer, comprising:
a main memory;
one or more processors; and
one or more programs, stored in the main memory and executed by the one or more processors, the programs collecting including instructions for performing the computer-executed method of claim 22.

44. A computer-executed method of displaying information comprising:
(A) obtaining, responsive to a user query, an album from a remote computer, wherein
the album comprises a plurality of links to a plurality of Internet-accessible documents, each link in the plurality of links specifying a location of an Internet-accessible document in the plurality of Internet-accessible documents,
a first link in the plurality of links is a link to a first static graphic representation stored in a document repository in a remote location, wherein the first static graphic representation is of a document retrieved from the Internet at a time before the obtaining (A), and
a second link in the plurality of links is a link to a location of a first image for a selected search result from a hit description for the selected search result in a search results schema;
(B) retrieving, responsive to said user query, all or a portion of the plurality of Internet-accessible documents in the plurality of Internet-accessible documents over the Internet including the first static graphic representation and the first image; and
(C) displaying all or a portion of the plurality of Internet-accessible documents in the plurality of Internet-accessible documents on a graphic output device.

45. The computer-executed method of claim 44, wherein the displaying (C) further comprises displaying all or a portion of the plurality of Internet-accessible documents in an order specified by the album.

46. The computer-executed method of claim 44, wherein the displaying (C) further comprises:
displaying a first representation of a first document in the plurality of Internet-accessible documents at a center position of the graphic output device, and
displaying a second representation of a second document in the plurality of Internet-accessible documents at an off-center position of the graphic output device, wherein the second representation is displayed rotated about a first axis of rotation that lies between the center position and the off-center position of the graphic output device.

47. The computer-executed method of claim 46, the method further comprising receiving user input shifting the second representation to the center position of the graphic output device.

48. The computer-executed method of claim 44, wherein the displaying (C) further comprises displaying a live version of a web page corresponding to the first representation, responsive to a user selection of the first representation.

49. A computer program product for use in conjunction with a computer system, the computer program product comprising a computer readable storage medium and a computer program mechanism embedded therein, the computer program mechanism comprising instructions for performing the computer-executed method of claim 44.

50. A computer, comprising:
a main memory;
one or more processors; and
one or more programs, stored in the main memory and executed by the one or more processors, the programs collecting including instructions for performing the computer-executed method of claim 44.

51. A computer-executed method comprising:
(A) receiving a query for product or service information;
(B) generating or retrieving a search results schema for a plurality of products or services that match said query, wherein the search results schema comprises a hit description for all or a portion of the products or services in said plurality of plurality of products or services;
(C) generating or retrieving a plurality of result details layout schemas, wherein each result details layout schema in said plurality of result details layout schemas corresponds to a product or service in said plurality of products or services, and wherein the search results schema specifies a location for each result details layout schema in all or a portion of the plurality of result details layout schemas; and
(D) creating a first web page, wherein said first web page comprises instructions for encoding a first representation of a first product or service in said plurality of products or services in a first position said first web page, wherein the first representation is specified, in part, by the search results schema and, in part, by a first result details layout schema in said plurality of result details layout schemas.

52. The computer-executed method of claim 51, wherein the first position is a center position of the first web page and wherein the first web page further comprises instructions for:
encoding a second representation of a second product or service in said plurality of products or services in a first off-center position of said second web page relative to the first representation, wherein the second representation is rotated about a first axis of rotation that lies between the center position and the first off-center position of the first web page and wherein the second representation is specified by the search results schema and a second result details layout schema in said plurality of result details layout schemas.

53. The computer-executed method of claim 51, wherein the search results schema comprises a description of a first product or service in said plurality of products or services, a title of the product or service, and a URL that a user will be directed to when the user selects the first product or service.

54. The computer-executed method of claim 51, wherein the first result details layout schema comprises a size and a background color of said first representation.

55. The computer-executed method of claim 51, wherein the first result details layout schema comprises:
text describing the first product or service and a position that the text is to be placed in the first representation or
an image describing the first product or service and a position that the image is to be placed in the first representation.

56. The computer-executed method of claim 52, wherein said first web page comprises instructions, responsive to a selection of the second representation in the first off-center position, for:
shifting the first representation to a second off-center position of said first web page thereby causing the first representation to be displayed at the second off-center position rotated about a second axis of rotation that lies between the center position and the second off-center position of the first web page;
shifting the second representation to the center position of the first web page, thereby causing the second representation to be displayed at the center position in a manner that is no longer rotated about the first axis of rotation; and
displaying a third representation of a third product or service in said plurality of products or service in said first off-center position of said first web page, wherein the third representation is rotated about said first axis of rotation and wherein the third representation is specified by the search results schema and a third result details layout schema in said plurality of result details layout schemas.

57. The computer-executed method of claim 56 wherein, responsive to a selection of the first representation in the second off-center position, the computer-executed method further comprises:
shifting the first representation to the center position of the first web page thereby causing the first representation to be displayed at the center position in a manner that is no longer rotated about the second axis of rotation; and
shifting the second representation to the first off-center position thereby causing the second representation to be displayed at the first off-center position in a manner that is rotated about the first axis of rotation.

58. The computer-executed method of claim 51, wherein the first web page further comprises instructions, responsive to a selection of the first representation, for linking to a URL specified by code corresponding to the first search result in the search results schema.

59. The computer-executed method of claim 51, wherein the first web page further comprises instructions, responsive to a selection of the first representation, for displaying a description of said first product or service, a title of the first product or service, and a URL that contains more information about the first product or service.

60. The computer-executed method of claim 52, wherein the first web page further comprises instructions for providing a toggle bar with the second web page so that,
when a search requester pulls the toggle bar in a first direction, a representation of a search result in the plurality of search results shifts from the first off-center position to the center position, and from the center position to a second off-center position responsive to the pull in the first direction; and
when the search requester pulls the toggle bar in a second direction, a representation of a search result in the first plurality of search results shifts from the second off-center position to the center position, and from the center position to the first off-center position responsive to the pull in the second direction.

61. The computer-executed method of claim 51, the computer-executed method further comprising:
(E) receiving a selection of (i) a selected product or service in said plurality of products or services and (ii) an identification of an album, wherein the album comprises a plurality of records, each record comprising an address of a document or a data structure; and
(F) performing, responsive to the receiving (E), a computer-executed method comprising:
(i) obtaining a location of an image for the selected search result from the hit description for the selected search result in the search results schema; and
(ii) adding a record to the album, wherein the record comprises the location of the image.

62. The computer-executed method of claim 61, the method further comprising:
(G) receiving a request to review the album; and
(H) creating, responsive to the receiving (G), a second web page, wherein said second web page comprises instructions for:
encoding a first image of a first document or a first data structure addressed by a first record in the plurality of records in the album in a center position of said second web page, and
encoding a second image of a second document or a second data structure addressed by a second record in the plurality of records in a first off-center position of said second web page relative to the first image, wherein the second image is rotated about a first axis of rotation that lies between the center position and the first off-center position of the second web page.

63. The computer-executed method of claim 62, wherein the first image or the second image is the image for the selected search added to the album by the performing (F).

64. The computer-executed method of claim 62, wherein the first image is the image for the selected search added to the album by the performing (F) and wherein the first image is modified between
(i) a time when the location of the image for the selected search result is added to a record in the album by the performing (F), and
(ii) a time when the creating (H) encodes the first image.

65. The computer-executed method of claim 64, wherein the first image is modified between (i) a time when the location of the image for the selected search result is added to a record in the album by the performing (F) and (ii) a time when the creating (H) encodes the first image in order to include an updated price or availability for a product or a service.

66. The computer-executed method of claim 61, wherein a record in the plurality of records is a link is to a static graphic representation stored in a document repository in a remote location, wherein the static graphic representation is a static graphic representation of a document retrieved from the Internet at a time before the receiving (A).

67. The computer-executed method of claim 61, the computer-executed method further comprising:
(G) receiving a request to share the album with a party associated with a remote computer; and
(H) performing, responsive to the request, a computer-executed method comprising:
(i) forming a link to the album stored in a remote location; and
(ii) causing an invitation to view the album to be sent to the remote computer, wherein the invitation comprises the link.

68. A computer program product for use in conjunction with a computer system, the computer program product comprising a computer readable storage medium and a computer program mechanism embedded therein, the computer program mechanism comprising instructions for performing the computer-executed method of claim 51.

69. A computer, comprising:
a main memory;
one or more processors; and
one or more programs, stored in the main memory and executed by the one or more processors, the programs collecting including instructions for performing the computer-executed method of claim 51.

70. A computer-executed method comprising:
(A) sending a product or service query; and
(B) displaying a first web page using an information construct, wherein
the information construct comprises a search results schema or is derived from the search results schema,
the search results schema comprises a hit description for each product or service in a plurality of products or services that match the product or service query, and
a hit description in the search results schema specifies a location of a result details layout schema in a plurality of result details layout schemas, and wherein said first web page comprises instructions for
encoding a first representation of a first search result in said plurality of search results in a first position in said first web page, wherein the first representation is specified, in part, by the search results schema and, in part, by a first result details layout schema in said plurality of result details layout schemas.

71. The computer-executed method of claim 70, wherein the first position is a center position in the first web page and wherein the first web page further comprises instructions for:
encoding a second representation of a second search result in said plurality of search results in a first off-center position of said first web page relative to the first representation, wherein the second representation is rotated about a first axis of rotation that lies between the center position and the first off-center position of the first web page and wherein the second representation is specified, in part, by the search results schema and, in part, by a second result details layout schema in said plurality of result details layout schemas.

72. The computer-executed method of claim 70, wherein the search results schema comprises a description of a first product or service in said plurality of products or services, a title of the first product or service, and a URL that a user will be directed to when the user selects the first product or service.

73. The computer-executed method of claim 70, wherein the first result details layout schema comprises a size and a background color of said first representation.

74. The computer-executed method of claim 70, wherein the first result details layout schema comprises:
text describing the first product or service and a position that the text is to be placed in the first representation, or
an image describing the first product or service and a position that the image is to be placed in the first representation.

75. The computer-executed method of claim 70, wherein said first web page comprises instructions, responsive to a selection of the second representation in the first off-center position, for:
shifting the first representation to a second off-center position of said first web page thereby causing the first representation to be displayed at the second off-center position rotated about a second axis of rotation that lies between the center position and the second off-center position of the first web page;
shifting the second representation to the center position of the first web page, thereby causing the second representation to be displayed at the center position in a manner that is no longer rotated about the first axis of rotation; and
displaying a third representation of a third product or service in said plurality of products or services in said first off-center position of said first web page, wherein the third representation is rotated about said first axis of rotation and wherein the third representation is specified by the search results schema and a third result details layout schema in said plurality of result details layout schemas.

76. The computer-executed method of claim 75, responsive to a selection of the first representation in the second off-center position, the first web pager further comprises instructions for:
shifting the first representation to the center position of the first web page thereby causing the first representation to be displayed at the center position in a manner that is no longer rotated about the second axis of rotation; and
shifting the second representation to the first off-center position thereby causing the second representation to be displayed at the first off-center position in a manner that is rotated about the first axis of rotation.

77. The computer-executed method of claim 70, wherein the first web page further comprises instructions, responsive to a selection of the first representation, for linking to a URL specified by code corresponding to the first product or service in the search results schema.

78. The computer-executed method of claim 70, wherein the first web page further comprises instructions, responsive to a selection of the first representation, for displaying a description of said first product or service, a title of the first product or service, and a URL that contains more information about the first product or service.

79. The computer-executed method of claim 71, wherein the first web page further comprises instructions for providing a toggle bar in the first web page so that,
when a search requester pulls the toggle bar in a first direction, a representation of a product or service in the plurality of products or services shifts from the first off-center position to the center position, and from the center position to a second off-center position responsive to the pull in the first direction; and
when the search requester pulls the toggle bar in a second direction, a representation of a product or service in the first plurality of search results shifts from the second off-center position to the center position, and from the center position to the first off-center position responsive to the pull in the second direction.

80. The computer-executed method of claim 70, the computer-executed method further comprising:
(C) receiving a selection of (i) a selected product or service in said plurality of products or services displayed on the first web page and (ii) an identification of an album, wherein the album comprises a plurality of records, each record comprising an address of a document or a data structure; and
(D) performing, responsive to the receiving (C), a computer-executed method comprising:
(i) obtaining a location of an image for the selected product or service from the hit description for the selected product or service in the search results schema; and
(ii) adding a record to the album stored, wherein the record comprises the location of the image.

81. The computer-executed method of claim 80, wherein a record in the plurality of records is stored on a remote computer and the receiving (C) comprises obtaining the record from the remote computer.

82. The computer-executed method of claim 80, the computer-executed method further comprising:
(E) receiving a request to review the album; and
(F) creating, responsive to the receiving (E), a second web page, wherein said second web page comprises instructions for
encoding a first image of a first document or a first data structure addressed by a first record in the plurality of records in the album in a center position of said second web page, and
encoding a second image of a second document or a second data structure addressed by a second record in the plurality of records in a first off-center position of said second web page relative to the first image, wherein the second image is rotated about a first axis of rotation that lies between the center position and the first off-center position of the second web page.

83. The computer-executed method of claim 82, wherein the first image or the second image is the image for the selected product or service added to the album by the performing (D).

84. The computer-executed method of claim 82, wherein the first image is the image for the selected search added to the album by the performing (D) and wherein the first image is modified between
(i) a time when the location of the image for the selected search result is added to a record in the album by the performing (D), and
(ii) a time when the creating (H) encodes the first image into said third web page.

85. The computer-executed method of claim 84, wherein the first image is the image for the selected search added to the album by the performing (D) and wherein the first image is modified between
(i) a time when the location of the image for the selected search result is added to a record in the album by the performing (D), and
(ii) a time when the creating (F) encodes the first image in order to include an updated price or availability for a product or a service.

86. The computer-executed method of claim 80, wherein a record in the plurality of records is a link is to a static graphic representation stored in a document repository in a remote location, wherein the static graphic representation is a static graphic representation of a document retrieved from the Internet at a time before the sending (A).

87. The computer-executed method of claim 80, the computer-executed method further comprising:
(E) receiving a request to share the album with a party associated with a remote computer; and
(F) performing, responsive to the request, a computer-executed method comprising:
(i) forming a link to the album stored in the remote location; and
(ii) causing an invitation to view the album to be sent to the remote computer, wherein the invitation comprises the link.

88. A computer program product for use in conjunction with a computer system, the computer program product comprising a computer readable storage medium and a computer program mechanism embedded therein, the computer program mechanism comprising instructions for performing the computer-executed method of claim 70.

89. A computer, comprising:
a main memory;
one or more processors; and
one or more programs, stored in the main memory and executed by the one or more processors, the programs collecting including instructions for performing the computer-executed method of claim 70.
